(19) United States
(12) Patent Application Publication
(10) Pub. No.: US 2024/0173112 A1
(43) Pub. Date: May 30, 2024

(54) NOZZLE AND ORAL IRRIGATOR DEVICE

(71) Applicant: GUANGZHOU STARS PULSE CO.,LTD., GUANGZHOU (CN)

(72) Inventors: JUNWEI GUAN, GUANGZHOU (CN); JIANQUN CHEN, GUANGZHOU (CN)

(21) Appl. No.: 18/433,532

(22) Filed: Feb. 6, 2024

Related U.S. Application Data
(63) Continuation of application No. PCT/CN22/82575, filed on Mar. 23, 2022.

(30) Foreign Application Priority Data
Aug. 13, 2021 (CN) 202110930404.0
Aug. 13, 2021 (CN) 202110932859.6
Aug. 13, 2021 (CN) 202121908525.7
Aug. 13, 2021 (CN) 202121910661.X

(51) Int. Cl. A61C 17/02

(52) U.S. Cl. CPC A61C 17/0202

(57) ABSTRACT

A nozzle and an oral irrigator device are provided. The oral irrigator device includes an irrigator body and the nozzle. The oral irrigator device defines a first direction, a second direction, and a third direction that are perpendicular to each other. The nozzle includes a main body portion extending along the first direction away from the irrigator body and an extension portion connected to one end of the main body portion. The extension portion obliquely extends along the second direction away from the main body portion. The extension portion includes a free end. The outlet is defined on an end surface of the free end of the extension portion; at least one section of an outer contour of the end surface of the free end of the extension portion is straight.

### TECHNICAL FIELD

The present disclosure relates to a technical field of oral cleaning tools, and in particular to a nozzle and an oral irrigator device having the same.

### BACKGROUND

In the prior art, an outer contour of the end surface of a nozzle of an oral irrigator device is generally configured to be circular or elliptical, which is relatively smooth in shape. During a process of cleaning teeth, the water outlet end of the nozzle is prone to slipping due to saliva in an oral cavity of a user. If the nozzle is slipped to the gums, the gums may be damaged. Contact between the nozzle and surfaces of two adjacent teeth of the teeth is in point contact, so a pressure of the nozzle on the surfaces of the two adjacent teeth is large, which is also easy to damage the teeth. Moreover, if the nozzle slides off from the teeth or slides to cause displacement, cleaning efficiency and cleaning effect on the teeth are reduced.

### SUMMARY

The present disclosure discloses a nozzle and an oral irrigator device having the same. The nozzle is not prone to slipping during use and improves cleaning efficiency and cleaning comprehensiveness of the nozzle on teeth.

In a first aspect, embodiments of the present disclosure disclose the nozzle of the oral irrigator device. The nozzle is configured to connect to an irrigator body of the oral irrigator device. The nozzle comprises an outlet, a main body portion, and an extension portion. The extension portion is connected to one end of the main body portion. The extension portion comprises a free end disposed away from the main body portion. The outlet is defined on an end surface of the free end of the extension portion. At least one section of an outer contour of the end surface of the free end of the extension portion is straight.

In one optional embodiment, the nozzle defines a first direction, a second direction, and a third direction. The first direction, the second direction, and the third direction are perpendicular to each other. The main body portion is extended along the first direction. The extension portion obliquely extends along the second direction away from the main body portion. The extension portion comprises a first side wall and a second side wall disposed opposite to the first side wall. The first side wall and the second side wall are disposed along the third direction. The end surface of the free end of the extension portion intersects the first side wall to define a first intersection edge. The end surface of the free end of the extension portion intersects the second side wall to define a second intersection edge. At least one of the first intersection edge and the second intersection edge is a straight edge.

In a second aspect, the embodiments of the present disclosure disclose oral irrigator device including the nozzle mentioned above.

At least one of the first intersection edge and the second intersection edge is the straight edge. By such arrangement, during actual use of the oral irrigator device, the free end of the nozzle is aligned with surfaces of two adjacent teeth of a user. At this time, the free end of the nozzle is placed against a tooth gap between the two adjacent teeth through an action of the at least one straight edge on an outer edge of the end surface of the free end of the extension portion. Compared with a conventional oral irrigator device where an outer peripheral side of a nozzle thereof having a circular arc surface or an elliptical arc surface, the at least one straight edge in the present disclosure positions the nozzle to a certain extent, thereby preventing the nozzle from slipping on the surfaces of the two adjacent teeth to a certain extent and improving the cleaning efficiency and the cleaning comprehensiveness of the nozzle on the teeth.

### BRIEF DESCRIPTION OF DRAWINGS

FIG. 1 is a structural schematic diagram of an oral irrigator device according to a first embodiment of the present disclosure.

FIG. 2 is another structural schematic diagram of the oral irrigator device according to the first embodiment of the present disclosure.

FIG. 3 is an enlarged schematic diagram of area L shown in FIG. 2.

FIG. 4 is a cross-sectional schematic diagram of a nozzle according to the first embodiment of the present disclosure.

FIG. 5 is a structural schematic diagram of the nozzle according to the first embodiment of the present disclosure.

FIG. 6 is a structural schematic diagram of the oral irrigator device according to a second embodiment of the present disclosure.

FIG. 7 is a structural schematic diagram of a first embodiment of the nozzle according to the second embodiment of the present disclosure.

FIG. 8 is a structural schematic diagram of the nozzle shown in FIG. 7.

FIG. 9 is another structural schematic diagram of the nozzle shown in FIG. 7.

FIG. 10 is an enlarged schematic diagram of area M shown in FIG. 9.

FIG. 11 is another structural schematic diagram of the nozzle shown in FIG. 7.

FIG. 12 is an enlarged schematic diagram of area N shown in FIG. 11.

FIG. 13 is a structural schematic diagram of a second embodiment of the nozzle according to the second embodiment of the present disclosure.

FIG. 14 is a structural schematic diagram of the nozzle shown in FIG. 13 where the nozzle is installed on an irrigator body of the oral irrigator device.

FIG. 15 is a structural schematic diagram of the oral irrigator device according to a third embodiment of the present disclosure.

FIG. 16 is a structural schematic diagram of the nozzle according to the third embodiment of the present disclosure.

FIG. 17 is a cross-sectional schematic diagram of the nozzle according to the third embodiment of the present disclosure.

FIG. 18 is an enlarged schematic diagram of area I shown in FIG. 17.

FIG. 19 is a cross-sectional schematic diagram of the nozzle taken along the line A-A.

FIG. 20 is an enlarged schematic diagram of area J shown in FIG. 16.

FIG. 21 is another structural schematic diagram of the nozzle shown in FIG. 16.

FIG. 22 is an enlarged schematic diagram of area K shown in FIG. 21.

FIG. 23 is a structural schematic diagram of the oral irrigator device according to a fourth embodiment of the present disclosure.

FIG. 24 is an exploded schematic diagram of the oral irrigator device shown in FIG. 23.

FIG. 25 is a partial cross-sectional schematic diagram of the nozzle according to the fourth embodiment of the present disclosure.

FIG. 26 is an enlarged schematic diagram of area F shown in FIG. 25.

FIG. 27 is an enlarged schematic diagram of area G shown in FIG. 26.

FIG. 28 is an exploded schematic diagram of the oral irrigator device according to the fourth embodiment of the present disclosure.

FIG. 29 is a structural schematic diagram of a clamping piece and a fixing piece according to the fourth embodiment of the present disclosure.

FIG. 30 is a structural schematic diagram of the nozzle according to the fourth embodiment of the present disclosure.

FIG. 31 is a cross-sectional schematic diagram of the nozzle according to the fourth embodiment of the present disclosure, where a reinforcing ring is disposed on an outer peripheral wall of the abutting portion.

FIG. 32 is a cross-sectional schematic diagram of the nozzle according to the fourth embodiment of the present disclosure, where the reinforcing ring is disposed on an inner wall of the abutting portion.

FIG. 33 is a cross-sectional schematic diagram of the nozzle shown in FIG. 30.

### DETAILED DESCRIPTION

Technical solutions in the embodiments of the present disclosure will be clearly and completely described below in conjunction with the accompanying drawings in the embodiments of the present disclosure. Obviously, the described embodiments are only a part of the embodiments of the present disclosure, rather than all of the embodiments. Based on the embodiments of the present disclosure, all other embodiments obtained by those of ordinary skill in the art without creative work shall fall within the protection scope of the present disclosure.

The technical solution of the present disclosure will be further described below with reference to the embodiments and drawings.

### Embodiment 1

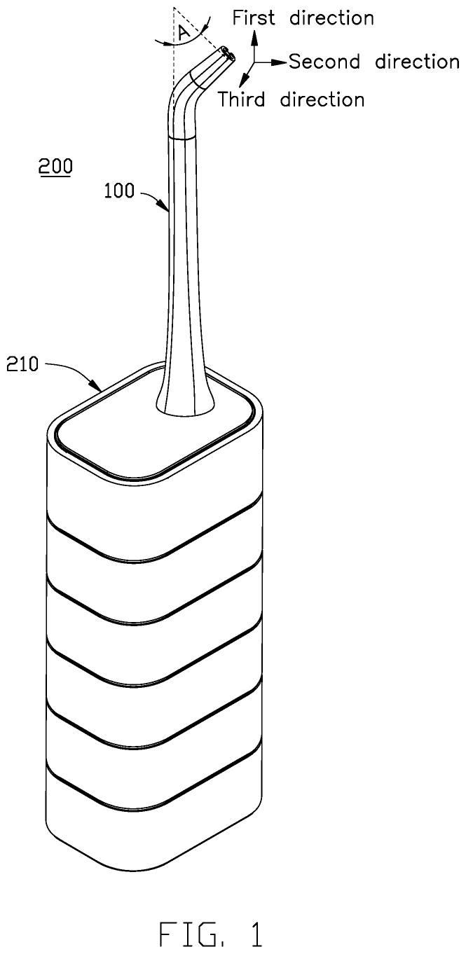

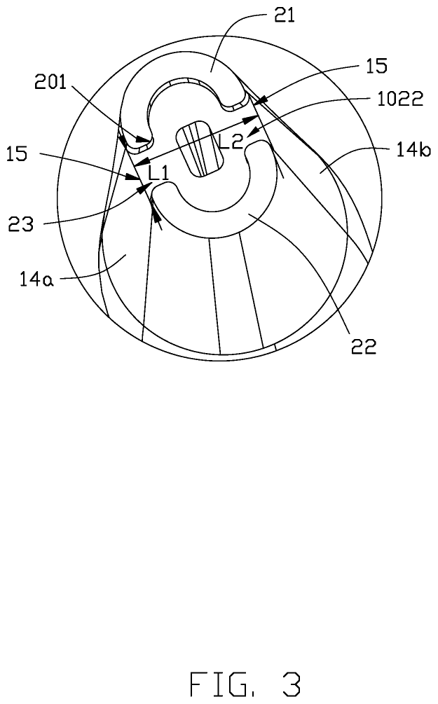

As shown in FIGS. 1-4, in one embodiment of the present disclosure, an oral irrigator device 200 is disclosed. The oral irrigator device 200 comprises an irrigator body 210 and a nozzle 100. The nozzle 100 is detachably connected to the irrigator body 210, and the nozzle 100 defines an inlet 131 and an outlet 132.

Specifically, the irrigator body 210 defines a water storage portion (such as a water storage tank) configured to storage liquid and a pump body (not shown in the drawings). The pump body is connected between the inlet 131 of the nozzle 100 and the water storage portion. When the pump body works, the liquid, such as water, stored in the water storage portion is pumped to the inlet 131 of the nozzle 100, then the water is pumped to the outlet 132 along a water outlet channel 13 in the nozzle 100, and is finally spurted out from the outlet 132 to irrigate an oral cavity of a user.

In some embodiments, the irrigator body 210 is of a cylindrical structure, which is selected from a cylinder, a prism, a square column, an oval column, etc. By configuring the irrigator body 210 as the cylindrical structure, the user can conveniently hold the irrigator body 210 to operate the oral irrigator device 200.

When installing the nozzle 100, the nozzle 100 is detachably connected to the irrigator body 210 by hand, that is, the user is able to assemble the nozzle 100 on the irrigator body 210 or disassemble the nozzle 100 from the irrigator body 210 without using any tool, enabling the nozzle 100 being detachably connected to the irrigator body 210 by hand, which is convenient for the user to use, assemble, and disassemble. Optionally, the nozzle 100 and the irrigator body 210 may be connected together through clamping structures, threads, etc., which is not limited thereto.

Furthermore, the nozzle 100 comprises a main body portion 101 and an extension portion 102. The irrigator body 210 defines a first direction, a second direction, and a third direction. The first direction, the second direction, and the third direction are perpendicular to each other, which are shown in FIG. 1. The main body portion 101 extends along the first direction away from the irrigator body 210. The extension portion 102 is connected to one end of the main body portion 101. The extension portion 102 obliquely extends along the second direction away from the main body portion 101. The extension portion 102 comprises a first side wall 14a and a second side wall 14b disposed opposite to the first side wall 14a. The first side wall 14a and the second side wall 14b are disposed along the third direction. An end surface 1022 of a free end 1021 of the extension portion 102 intersects the first side wall 14a to define a first intersection edge, and the end surface 1022 of the free end 1021 of the extension portion 102 intersects the second side wall 14b to define a second intersection edge. At least one of the first intersection edge and the second intersection edge is a straight edge 15. The outlet 132 is defined on the end surface 1022 of the free end 1021 of the extension portion 102.

That is, the first intersection edge of the end surface 1022 of the free end 1021 of the extension portion 102 and the first side wall 14a is the straight edge 15, or, the second intersection edge of the end surface 1022 of the free end 1021 of the extension portion 102 and the second side wall 14b is the straight edge 15, or, both of the first intersection edge of the end surface 1022 of the free end 1021 of the extension portion 102 and the first side wall 14a and the second intersection edge of the end surface 1022 of the free end 1021 of the extension portion 102 and the second side wall 14b are straight edges 15.

By such arrangement, during actual use of the oral irrigator device 200, the free end 1021 of the nozzle 100 is aligned with surfaces of two adjacent teeth of a user. At this time, the free end 1021 of the nozzle 100 is placed against a tooth gap between the two adjacent teeth through an action of the at least one straight edge 15 on at least one outer edge of the end surface 1022 of the free end 1021 of the extension portion 102. Compared with a conventional oral irrigator device where an outer peripheral side of a nozzle thereof having a circular arc surface or an elliptical arc surface, the at least one straight edge 15 in the present disclosure positions the nozzle 100 to a certain extent, thereby preventing the nozzle 100 from slipping on surfaces of the two adjacent teeth to a certain extent and improving the cleaning efficiency and the cleaning comprehensiveness of the nozzle 100 on the teeth.

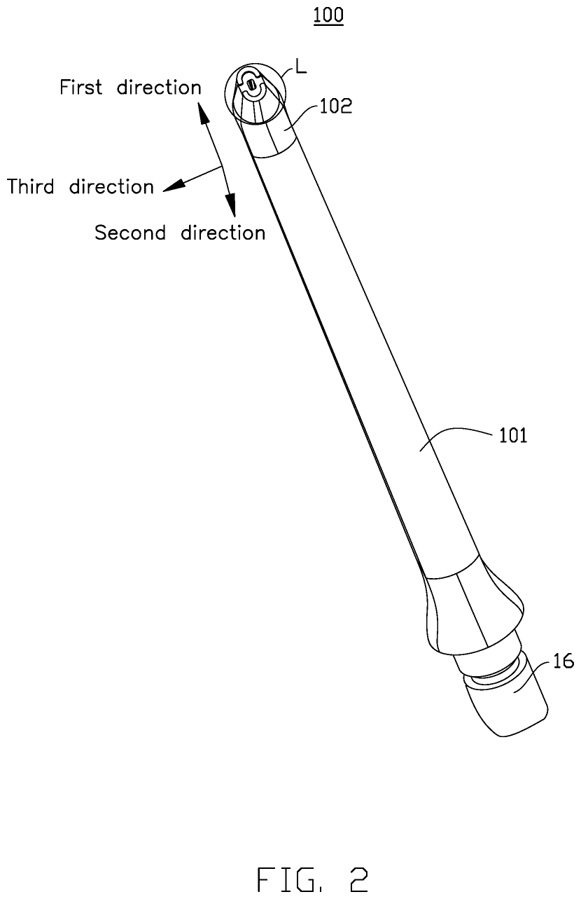

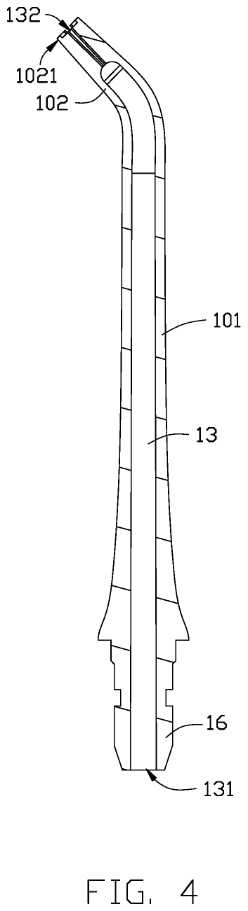

In some embodiments, as shown in FIGS. 2-5, the main body portion 101 and the extension portion 102 are disposed in a columnar shape. A boundary between the main body portion 101 and the extension portion 102 is located at a position, where the extension portion 102 starts to obliquely extend toward the second direction, of the extension portion 102. The main body portion 101 and the extension portion 102 in the embodiment are selected from cylinders, prisms, elliptical columns, or special-shaped columns. In the embodiment, as shown in FIGS. 2, 4, and 5, the main body portion 101 and the extension portion 102 are configured as the special-shaped columns for illustration.

Furthermore, the nozzle 100 further comprises a connecting portion 16. The connecting portion 16 is connected to the main body portion 101. The nozzle 100 is connected to the irrigator body 210 through the connecting portion 16. The main body portion 101 is of the columnar shape. Along the first direction, areas of cross sections of the main body portion 101 gradually decrease, where the cross sections of the main body portion 101 are cross sections obtained by cutting the main body portion 101 in a direction perpendicular to the first direction. During a process of assembling the nozzle 100 on the irrigator body 210 of the oral irrigator device 200, because the areas of the cross sections of the main body portion 101 gradually increase in a direction from the main body portion 101 to the irrigator body 210 of the oral irrigator device 200 (i.e., a direction opposite to the first direction), when the main body portion 101 moves toward the irrigator body 210 of the oral irrigator device 200 and a force is applied on the nozzle 100 in the direction from the main body portion 101 to the irrigator body 210 to install the nozzle 100 on the irrigator body 210, a surface of the main body portion 101 provides a relatively stable acting point for the user, which increases a contact area between a surface of the nozzle 100 and a force application part (such as a hand of the user) of the user, making an assembling operation comfortable.

Optionally, the connecting portion 16 is a connecting column. The connecting column is thinner than the main body portion 101. Through the connecting portion 16, the nozzle 100 is conveniently connected to the irrigator body 210 of the oral irrigator device 200. Furthermore, the main body portion 101, the connecting portion 16, and the extension portion 102 are integrally formed, which improve a structural strength and service life of the nozzle 100 of the embodiment.

In some embodiments, at least one of the first side wall 14a and the second side wall 14b of the extension portion 102 is a flat surface. That is, in actual use, the first side wall 14a is configured to be the flat surface, the second side wall 14b is configured to be the flat surface, or both of the first side wall 14a and the second side wall 14b are flat surfaces. In other words, there are at least one flat surface and at least one straight edge 15 on the outer edge of the end surface 1022 of the extension portion 102. During the actual use of the nozzle 100, the at least one flat surface is placed against the surfaces of the two adjacent teeth, and the at least one straight edge 15 is placed against the tooth gap between the two adjacent teeth. Compared with a conventional oral irrigator device where the outer peripheral side of the nozzle thereof having the circular arc surface or the elliptical arc surface, the at least one straight edge 15 and the at least one flat surface in the embodiment position the nozzle 100 to a certain extent, thereby preventing the nozzle 100 from slipping to a certain extent. When the user moves the nozzle 100, the at least one straight edge 15 slides up and down along the tooth gap between the two adjacent teeth. That is, the at least one straight edge 15 further plays a guiding role, which improves the cleaning efficiency and the cleaning comprehensiveness of the nozzle 100 on the teeth, making the nozzle 100 convenient for the user to use and operate.

In some embodiments, as shown in the drawings of the first embodiment, the first side wall 14a and the second side wall 14b are configured to be the flat surfaces for illustration. Specifically, the first side wall 14a and the second side wall 14b are the flat surfaces, so there are two straight edges 15 corresponding to the two flat surfaces. The first side wall 14a and the second side wall 14b are respectively located on two opposite sides of the extension portion 102, and the two straight edges 15 are respectively located on the two opposite sides of the extension portion 102. When the nozzle 100 moves left and right in the oral cavity, one of the straight edges 15 on one side of the extension portion 102 is placed in the tooth gap between the two adjacent teeth, and the first side wall 14a or the second side wall 14b that is corresponding located on the one side of the extension portion 102 just abuts against the surfaces of the two adjacent teeth. That is, by arrangements of the flat surfaces and the straight edges 15, the first side wall 14a and the second side wall 14b are capable of abutting against the surfaces of the two adjacent teeth at the same time, so that a position of the nozzle 100 is multiply limited, and the nozzle 100 hardly slips during use.

Furthermore, the first side wall 14a and the second side wall 14b extend from the extension portion 102 to the main body portion 101 and the first side wall 14a and the second side wall 14b respectively extend to midpoints of the main body portion 101 along a length direction of the main body portion 101. In a process of disassembling or assembling the nozzle 100, the first side wall 14a and the second side wall 14b are configured to the flat surfaces, which facilitate the user to apply a force thereon, making the hand of the user not easy to slip. That is, when the user disassembles the nozzle 100 from the oral irrigator device 200, the first side wall 14a and the second side wall 14b are configured as the flat surfaces to provide relatively stable acting points for the user.

Furthermore, along the first direction, the two straight edges are obliquely disposed toward the main body portion. When the user holds the irrigator body 210 to operate the oral irrigator device 200, the end surface 1022 of the free end 1021 of the extension portion 102 is enabled to be parallel to the surfaces of the two adjacent teeth of the user by inclining the irrigator body 210 with a small angle, so that the outlet 132 directly faces the surfaces of the two adjacent teeth of the user. At this time, the liquid spurted from the outlet 132 directly clean the surfaces of the two adjacent teeth of the user, which is not only convenient for the user to operate and position the nozzle 100, but also improves an irrigating strength of the oral irrigator device 200.

Optionally, an included angle A between each of the straight edges 15 and the first direction ranges from 0-60 degrees, such as 0 degree, 15 degrees, 30 degrees, 60 degrees, etc. By enabling the included angle A between each of the straight edges 15 and the first direction being 0-60 degrees, when the user holds the irrigator body 210, the two straight edges 15 are allowed to abut against the tooth gap between the two adjacent teeth of the user by inclining the irrigator body 210 toward the user with a small angle, which is convenient to position the nozzle 100, thereby preventing the nozzle 100 from slipping.

In some embodiments, a length L1 of the at least one straight edge 15 is not greater than 8 mm. If the length of the at least one straight edge 15 is greater than 8 mm, one end of the at least one straight edge easily touches the gums to cause damage to the gums. That is, by making the length of the at least one straight edge 15 being less not greater than 8 mm, such as 8 mm, 7 mm, 6 mm, 5 mm, etc., when in use, the at least one straight edge 15 is not prone to touching the gums, and the gums are not prone to the damage.

In some embodiments, the end surface 1022 of the free end 1021 of the extension portion 102 is intersected with the first side wall 14a and the second side wall 14b to form two straight edges 15. The two straight edges 15 are parallel to each other. A width L2 between the two straight edges 15 is not greater than 4 mm. It is understood that the width between the two straight edges 15 refers to a distance between the two straight edges 15. Optionally, the width L2 between the two straight edges 15 is 2.5-3 mm, such as 2.5 mm, 2.6 mm, 2.7 mm, 2.8 mm, 2.9 mm, 3 mm, etc. When the width between the two straight edges 15 is greater than 4 mm, a first one of the two straight edges 15 on the end surface 1022 of the free end 1021 of the extension portion 102 abuts against the tooth gap between the two adjacent teeth, a second one of the two straight edges 15 easily interferes with the two adjacent teeth, which affects use of the nozzle 100. That is, the width between the two straight edges 15 is set to be not greater than 4 mm, and during the use of the nozzle 100, edges of the end surface 1022 of the free end 1021 of the extension portion 102 does not easily interfere with the two adjacent teeth.

Furthermore, the free end 1021 of the extension portion 102 defines at least one first notch 23. The at least one first notch 23 penetrates the first side wall 14a and/or the second sidewall 14b, and the first notch 23 is communicated with the outlet 132. That is, in some embodiments, there is only one first notch 23, and the first notch 23 only penetrates the first side wall 14a or the second side wall 14b, or, there are two first notches, and the two first notches 23 penetrate the first side wall 14a and the second side wall 14b. When the end surface 1022 of the free end 1021 of the extension portion 102 is disposed against the surfaces of the two adjacent teeth, and after the liquid spurts out of the outlet 132, the liquid pass through the at least one first notch 23 and then irrigates the two adjacent teeth or the gums of the user. When the user uses the nozzle 100, the end surface 1022 of the free end 1021 of the extension portion 102 of the nozzle 100 directly faces the two adjacent teeth or the gums to be irrigated. At this time, a depth of the at least one first notch 23 allows that the two the outlet 132 does not in contact with the two adjacent teeth or the gums of the user, thereby preventing the outlet 132 from being blocked.

Optionally, the at least one first notch 23 defines first rounded corners 201, the first rounded corners 201 are respectively located at side edges of the at least one first notch 23. On one hand, the first rounded corners 201 prevent the free end 1021 of the extension portion 102 from scratching the gun, and on the other hand, the first rounded corners 201 guide the liquid spurting out of the at least one first notch 23 to a certain extent.

Furthermore, in the embodiment, there are two first notches 23. The first notches 23 penetrate the end surface 1022 of the free end 1021 of the extension portion 102 and intersect with at least part of the two straight edges 15, so that when the two straight edges 5 are places against the tooth gap between the two adjacent teeth, the liquid spurting out of the first notches 23 irrigates the surfaces of two adjacent teeth or gums as much as possible, and the liquid does not spurt out of other portions of the nozzle 100 nor splash to an outside of the oral cavity.

In an outer contour of the end surface 1022 of the free end 1021 of the extension portion 102, a first connecting section is connected to a first end of each of the two straight edges 15. A second connecting section is connected to a second end of each of the two straight edges 15. The first connecting section and the second connecting section are arc-shaped. The first connecting section is arched up toward a direction away from the second connecting section. The second connecting section is arched up toward a direction away from the first connecting section. At this time, the first notches 23 are located between ends of the two connecting sections, that is, the first connecting section and the second connecting section in the embodiment are convex arc-shaped sections, which are respectively defined as a first arc-shaped section 21 and a second arc-shaped section 22. The first arc-shaped section 21 and the second arc-shaped section 22 enclose the liquid spurting out of the outlet 132 to prevent the liquid from splashing.

Furthermore, the outlet 132 in the embodiment is slit-shaped, and an extension direction of the outlet 132 is consistent with an extension direction of the two straight edges 15. The outlet 132 is slit-shaped, which indicates that the outlet 132 is an elongated structure having a certain length and width. That is, the outlet 132 is a long-narrow-shaped hole. The long-narrow-shaped hole is a non-circular hole, and under a same moving distance, more liquid is spurted out of the outlet 132 than that of a circular outlet, so that the cleaning efficiency of the nozzle 100 on the two adjacent teeth is further improved.

In some embodiments, the outlet 132 is spaced apart from the two straight edges 15. That is, there is a certain distance between each of the two straight edges 15 and the outlet 132. When in use, the two straight edges 15 are placed against the tooth gap between the two adjacent teeth. At this time, the two straight edge 15 are spaced apart from the surfaces of the two adjacent teeth. Namely, when the liquid is spurted out from the outlet 132, the liquid directly irrigates the surfaces of the two adjacent teeth of the user, rather than being only limited around the tooth gap between the two adjacent teeth, which facilitates efficient cleaning of the surfaces of the two adjacent teeth and improves the cleaning efficiency of the oral irrigator device 200 of the embodiment.

In summary, since at least one of the first intersection edge and the second intersection edge of the present disclosure is the at least one straight edge 15, when the free end 1021 of the extension portion 102 of the nozzle 100 is aligned with surfaces of the two adjacent teeth of the user, the free end 1021 of the extension portion 102 of the nozzle 100 is conveniently placed against the tooth gap between the two adjacent teeth of the user through the action of the at least one straight edge 15 disposed at the one outer edge of the end surface 1022 of the free end 1021 of the extension portion 102. Compared with the conventional oral irrigator device where the outer peripheral side of the nozzle thereof having the circular arc surface or the elliptical arc surface, the at least one straight edge 15 in the present disclosure positions the nozzle 100 to a certain extent, thereby preventing the nozzle 100 from slipping on the surfaces of the two adjacent teeth to a certain extent and improving the cleaning efficiency and the cleaning comprehensiveness of the nozzle 100 on the teeth.

### Embodiment 2

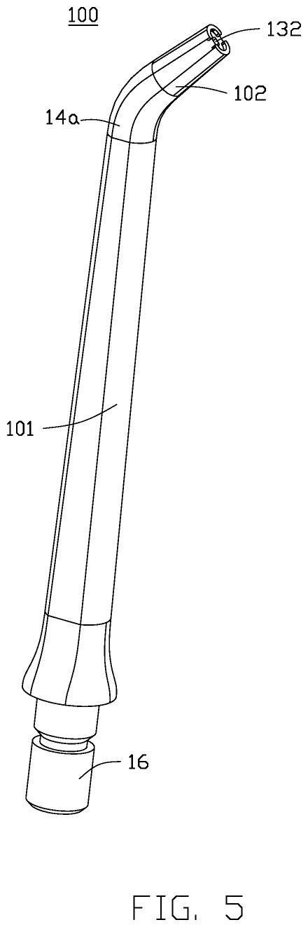

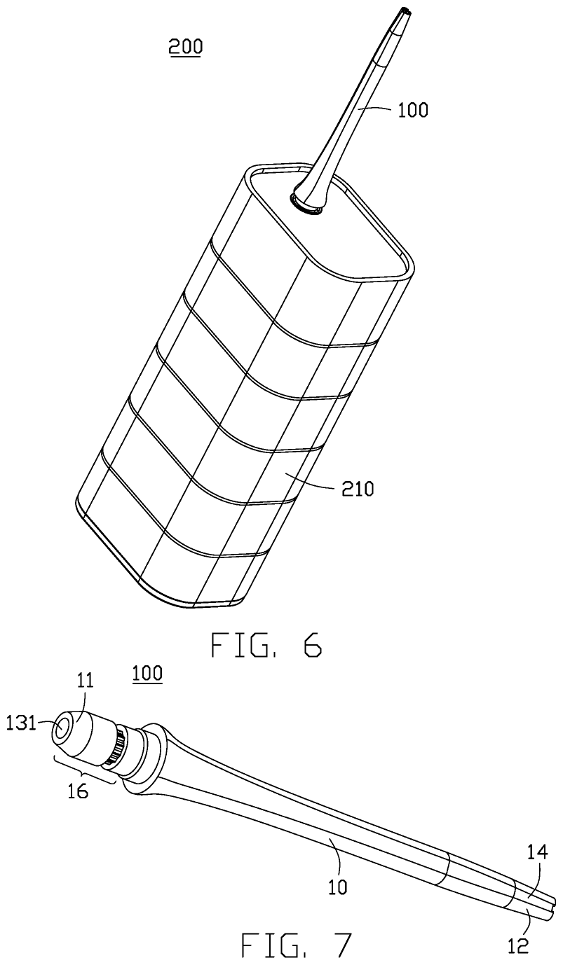

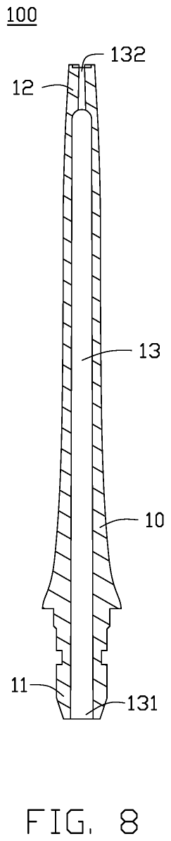

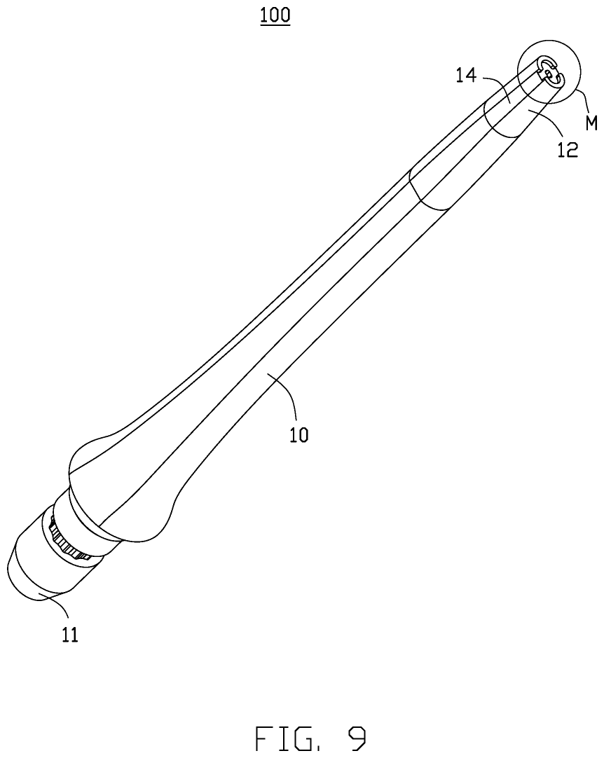

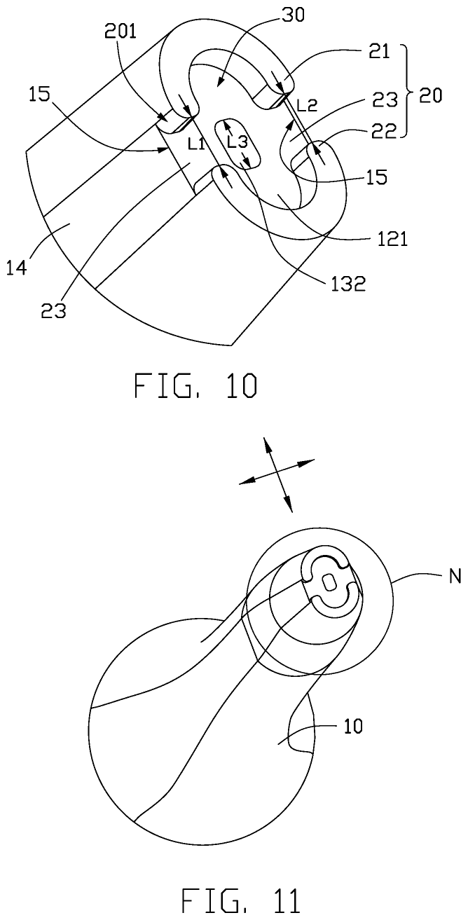

As shown in FIGS. 6-10, FIG. 6 is a structural schematic diagram of the oral irrigator device according to a second embodiment of the present disclosure, FIG. 7 is a structural schematic diagram of a first embodiment of the nozzle according to the second embodiment of the present disclosure, FIG. 8 is a structural schematic diagram of the nozzle shown in FIG. 7, FIG. 9 is another structural schematic diagram of the nozzle shown in FIG. 7, and FIG. 10 is an enlarged schematic diagram of area M shown in FIG. 9. According to the second embodiment of the present disclosure, the oral irrigator device 200 is provided. The oral irrigator device 200 comprises an irrigator body 210 and a nozzle 100. The nozzle 100 is detachably connected to the irrigator body 210 by hand. Optionally, the nozzle 100 is connected to the irrigator body 210 through fastening structures.

Specifically, the irrigator body 210 comprises a pump body disposed in the irrigator body 210, a water storage space, and a water channel (not shown in the drawings). A water inlet of the pump body is communicated with the water outlet space, and a water outlet of the pump body is communicated with the water channel. The nozzle 100 comprises a main body 10 and a first stop flange 20. The main body 10 comprises a first end 11 and a second end 12, and the main body 10 defines a water outlet channel 13. The water outlet channel 13 is communicated with the water channel. The water outlet channel 13 extends from the first end 11 to the second end 12 of the main body 10. The water outlet channel 13 defines an inlet 131 and an outlet 132. The inlet 131 is located at the first end 11 of the main body 10, and the outlet 132 is located on an end surface of the second end 12 of the main body 10. The first stop flange 20 protrudes from the end surface of the second end 12 of the main body 10. The first stop flange 20 encloses with the end surface of the second end 12 of the r: main body 10 to forms a first groove 30. The outlet 132 is defined on a bottom portion of the first groove 30. The first stop flange 20 defines at least one first notch 23, The at least one first notch 23 penetrates the first stop flange 20 in a radial direction of the end surface of the second end 12 of the main body 10. The at least one first notch 23 is communicated with the outlet 132. In one optional embodiment of the present disclosure, two first notches 23 are provided and respectively penetrate the first stop flange 20 in the radial direction of the end surface of the second end 12 of the main body 10. The two first notches 23 are respectively defined on two opposite sides of the outlet 132.

It should be understood that the first end 11 and the second end 12 of the main body 10 refer to parts respectively located at two end of the main body 10 and having a certain length along a length direction of the main body 10, rather than end surfaces of the main body 10. The inlet 131 and the outlet 132 refer to openings of the water outlet channel 13.

When using the nozzle 100 in the embodiment to clean the teeth, the second end 12 of the nozzle 100 needs to be placed close to two adjacent teeth to be cleaned, and the pump body disposed in the irrigator body 210 pumps liquid, such as water in the water storage space from the water channel into the water outlet channel 13, so that the liquid flows along the inlet 131 of the water outlet channel 13 and is spurted out from the outlet 132. During this process, if the second end 12 of the nozzle 100 is placed against surfaces of the two adjacent teeth, the first stop flange 20 located on the end surface of the second end 12 of the main body 10 is placed against the surfaces of the two adjacent teeth. At this time, there is a gap between the outlet 132 and the surfaces of the two adjacent teeth. Namely, even when the second end 12 of the nozzle 100 is placed against the surfaces of the two adjacent teeth, the outlet 132 is not blocked by the surface of the adjacent teeth. When the liquid in the water outlet channel 13 spurts out from the outlet 132, the first stop flange 20 guides the liquid, and the liquid is not prone to randomly splashing. The liquid spurting out from the outlet 132 firstly enters the first groove 30 and then spurts out from the two first notches 23 on the first stop flange 20. During this process, the liquid is decompressed after diffusing at the first groove 30, which prevents the liquid from splashing or damaging the gums, thereby improving the user experience during a use process of the nozzle 100.

Furthermore, an area of any one of cross sections of the first groove 30 is greater than an area of the outlet 132. It is understood that any one of the cross sections of the first groove 30 is a cross section obtained by cutting the first groove 30 along a direction perpendicular to the length direction of the main body 10. The area of the outlet 132 is an area formed by the outlet 132 surrounding the end surface of the second end 12 of the main body 10. That is, the outlet 132 is within the first groove 30, and a size of an inner cavity defined by the first groove 30 is greater than a size of the outlet 132. When the liquid spurts out from the outlet 132, the liquid enters a relatively large space (i.e., the first groove 30) from a relatively small space (i.e., the outlet 132). At this time, a pressure of the liquid is effectively reduced, which prevents the liquid from splashing or damaging the gums.

Furthermore, the outlet 132 is spaced apart from the first stop flange 20. That is, there is a certain distance between inner walls of the first stop flange 20 and the outlet 132. In this way, the inner cavity of the first groove 30 increases, where the first groove 30 is formed by enclosing the first stop flange with the end surface of the second end 12 of the main body 10. When the liquid enters into the first groove 30 from the outlet 132, the pressure of the liquid is effectively reduced.

Optionally, a ratio of the area of the outlet 132 to the area of any one of the cross sections of the groove is 1:8 to 1:5, such as 1:8, 1:7, 1:6 or 1:5, etc. In this way, the liquid spurting out of the outlet 132 is effectively decompressed.

In some embodiments, the main body 10 is columnar, which is selected from a cylinder, a prism, an elliptical column, or a special-shaped column. FIG. 7 and FIG. 9 in the embodiment show a case where the main body 10 is configured as the special-shaped column. Specifically, a connecting portion 16 is disposed on the first end 11 of the main body 10, and the connecting portion 16 is a connecting column. The connecting column is thinner than at least part of the main body 10. The nozzle 100 is conveniently connected to the irrigator body 210 of the oral irrigator device 200 through the connecting portion 16.

In the embodiment, along the direction from the first end 11 to the second end 12 of the main body 10, areas of cross sections of the main body 10 gradually decrease. It is understood that the cross sections of the main body 10 are cross sections obtained by cutting the main body 10 along the direction perpendicular to the length direction of the main body 10. During a installing process of the nozzle 100, when a force is applied on the nozzle 100 to install the nozzle 100 on the irrigator body 210 of the oral irrigator device 200, since the areas of the cross sections of the main body 10 of the nozzle 100 gradually increase in a direction of the main body toward the irrigator body 210 of the oral irrigator device 200, a side surface of the main body 10 provides a relatively stable acting point for the user, which increases a contact area between the side surface of the main body 10 of the nozzle 100 and a force application part (such as a hand) of the user, and makes it more comfortable to install the nozzle.

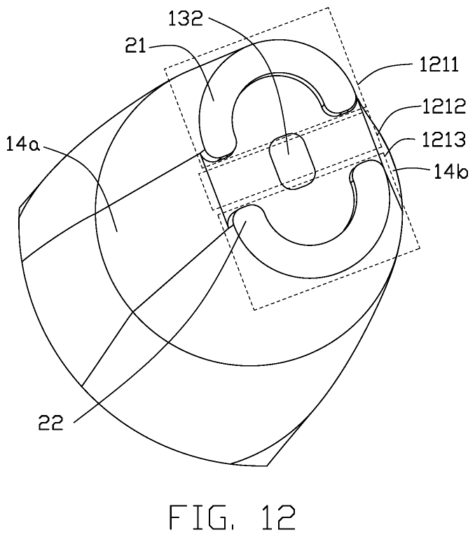

As shown in FIGS. 9-12, FIG. 11 is another structural schematic diagram of the nozzle shown in FIG. 7 and FIG. 12 is an enlarged schematic diagram of area N shown in FIG. 11. The second end 12 of the main body 10 in the embodiment is configured as an oblate column such that the end surface of the second end 12 of the main body 10 forms an oblong end surface 121. It is understood that the oblate column in the embodiment refers to a columnar structure in which each of a width of a left side and a width of a right side thereof is less than each of a width of the upper and a width of lower sides (as shown in FIG. 10) when viewed from the end surface of the second end 12 of the main body 10. The oblong end surface 121 of the main body 10 in the embodiment is the end surface disposed in a long strip shape and has arc edges on outer edges thereof. Moreover, the oblong end surface 121 of the main body 10 refers to a shape of the end surface of the second end 10 when viewed along an axial direction of the main body 10. Specifically, the oblong end surface 121 of the main body 10 comprises a first arc-shaped area 1211, a connecting area 1212, and a second arc-shaped area 1213. The first arc-shaped area 1211 and the second arc-shaped area 1213 are respectively located on two opposite sides of the connecting area 1212. In actual use, a length direction of the oblong end surface 121 of the main body 10 is consistent with a length direction of the two adjacent teeth. That is, an arrangement of the oblong end surface 121 of the main body 10 is adapted to shapes of the two adjacent teeth, which facilitates effective cleaning of the surfaces of the two adjacent teeth. Moreover, two ends of the oblong end surface 121 of the main body 10 in the length direction are respectively defined as the first arc-shaped area 1211 and the second arc-shaped area 1213. An outer edge of the first arc-shaped area 1211 and an outer edge of the second arc-shaped area 1213 (that are away from the connecting area 1212) are arc-shaped edges. That is, the outer edge of the first arc-shaped area 1211 and the outer edge of the second arc-shaped area 1213 are not angular, making the nozzle 100 not easy to scratch the gums and bringing a good experience. In an actual design process, the outlet 132 is at least partially located in the connecting area 1212. That is, the outlet 132 is located in the connecting area 1212, is located in the connecting area 1212 and the first arc-shaped area 1211, is located in the connecting area 1212 and the second arc-shaped area 1213, or is located in the first arc-shaped area 1213, the connecting area 1212 and the second arc-shaped area 1213 at the same time. Namely, the outlet 132 in the embodiment is located at a middle position of the oblong end surface 121 of the main body 10 along the radial direction of the second end 12 of the main body 10, so as to facilitate effective cleaning of the surfaces of the two adjacent teeth.

For instance, the first arc-shaped area 1211 and the second arc-shaped area 1213 are semicircular areas, and the first arc-shaped area 1211 and the second arc-shaped area 1213 are symmetrically disposed with respect to the connecting area 1212. That is, one side of the first arc-shaped area 1211 away from the connecting area 1212 and one side of the second arc-shaped area 1213 away from the connecting area 1212 are arc edges. In actual use, the user does not need to distinguish between a front side or a rear side of the nozzle 100, and only needs to make the length direction of the oblong end surface 121 of the main body 10 correspond to the length direction of the two adjacent teeth. Moreover, by arrangements that the outer edge of the first arc-shaped area 1211 and the outer edge of the second arc-shaped area 1213 are the arc edges, the end surface of the second end 12 of the main body 10 is enabled to adapt to the shape of the gums of most human bodies, which makes the nozzle 100 being not easy to cause damage to the gums.

Of course, in other embodiments of the present disclosure, the first arc-shaped area 1211 and the second arc-shaped area 1213 are arc-shaped areas of other shapes, such as areas each surrounded by a section of chord and a section of arc, as long as they are modifications under the concept of the present disclosure, which are within the protection scope of the present disclosure.

For instance, the connecting area 1212 is a square area, and the two opposite sides of the square area are respectively connected to a chord side of the first arc-shaped area 1211 disposed in a semicircle and a chord side of the second arc-shaped area 1213 disposed in a semicircle.

Furthermore, the first stop flange 20 in the embodiment comprises a first arc-shaped section 21 and a second arc-shaped section 22. The first arc-shaped section 21 extends along the outer edge of the first arc-shaped area 1211. The second arc-shaped section 22 extends along the outer edge of the second arc-shaped area 1213. Ends of the first arc-shaped section 21 is spaced apart from the ends of the second arc-shaped section 22 to form the two first notches 23. When the second end 12 of the main body 10 is placed against the surfaces of the two adjacent teeth, the first arc-shaped section 21 and/or the second arc-shaped section 22 is placed against the surfaces of the two adjacent teeth, and the liquid in the water outlet channel 13 spurts out from the outlet 132 and enters the first groove 30, then the liquid passes through the first notches 23, and the liquid irrigates the two adjacent teeth or the gums of the user. When using the nozzle 100, the user is able to directly place the second end 12 of the nozzle 100 on the two adjacent teeth or the gums to be irrigated. That is, an arrangement of the first arc-shaped section 21 or an arrangement of the second arc-shaped section 22 ensures that the outlet 132 does not directly in contact with the two adjacent teeth and the gums of the user, thereby preventing the outlet 132 from being blocked.

Furthermore, the ends of the first arc-shaped section 21 and/or the ends of the second arc-shaped section 22 define first rounded corners 201. That is, the ends of the first arc-shaped section 21 define the first rounded corners 201, the ends of the second arc-shaped section 22 define first rounded corners 201, or the ends of the first arc-shaped section 21 and the ends of the second arc-shaped section 22 define the first rounded corners 201. Through the first rounded corners 201, on the one hand, the ends of the first arc-shaped section 21 and the ends of the second arc-shaped section 22 are prevented from scratching the gums, and on the other hand, the arrangements of the first rounded corners 201 also play a certain guiding role for the liquid spurting out from the first notches 23 to avoid turbulence of the liquid.

In some embodiments, two first notches 23 are provided. The two first notches 23 are respectively located on two opposite sides of the first stop flange 20, so that liquid spurted out from the outlet are flushed out from two directions, thereby reducing the pressure of the liquid and further protecting the oral cavity of the user. Of course, in other embodiments of the present disclosure, more than two first notches are provided, such as three first notches, four first notches, or more than four first notches, etc. As long as modifications therein are made under the concept of the present disclosure, these modifications are all within the protection scope of the present disclosure.

In some embodiments, the first stop flange 20 is an annular flange extending along an outer circumference of the end surface of the second end 12 of the main body 10, and a total length of the first notches 23 on the annular flange is 1/7 to ¼ of a circumference of the annular flange. The present disclosure takes the two first notches 23 as an example for illustration. When the two first notches 23 are provided, a sum of a lengths L1 and a length L2 of the two first notches 23 along an extension direction of the annular flange is 1/7 to ¼ of the circumference of the annular flange, such as 1/7, ⅙, ⅕ or ¼, etc. When the total length of the two first notches 23 defined by the first stop flange 20 is less than 1/7 of the circumference of the first stop flange 20, the two first notches 23 are relatively narrow and hardly reduce the pressure of the liquid, and a flow rate of the liquid is relatively fast, which easily causes damage to the oral cavity of the user. When the total length of the two first notches 23 defined by the first stop flange 20 is greater than ¼ of the circumference of the first stop flange 20, the pressure of the liquid is too small, and the flow rate of the liquid is relatively slow, making it not easy to clean the surfaces of the two adjacent teeth and the gums.

Optionally, the length L1 or the length L2 of any one of the first notches 23 defined by the first stop flange 20 is not less than a length L3 of the outlet 132 along the length direction of the oblong end surface 121 of the main body 10. By such arrangement, control of the flow rate of the liquid is facilitated, and the oral cavity of the user is protected.

Furthermore, the first notches 23 extend from one side of the first stop flange 20 away from the end surface of the second end 12 of the main body 10 to the end surface of the second end 12 of the main body. That is, the first notches 23 penetrates the first stop flange 20 along a height direction of the first stop flange 20, and a bottom portion of each of the first notches 23 is flush with the end surface of the second end 12 of the main body 10, so that the liquid quickly spurted out from the outlet 132 is quickly discharged, and the liquid is not prone to turbulence.

Optionally, the depth of each of the first notches 23 is 0.3-1 mm, such as 0.3 mm, 0.5 mm, 0.7 mm, 0.9 mm, 1 mm, etc. That is, a height of the first stop flange 20 is 0.3-1 mm. In this way, when the second end 12 of the main body 10 of the nozzle 100 is placed against the surfaces of two adjacent teeth, the first stop flange 20 located on the end surface of the second end 12 of the main body 10 is placed against the surfaces of the two adjacent teeth. At this time, the gap is defined between the outlet 132 and the surfaces of two adjacent teeth (a width of the gap thereof is 0.3-1 mm). That is, even when the second end 12 of the main body 10 of the nozzle 100 is placed on the surfaces of the two adjacent teeth, the outlet 132 is not blocked by the surfaces of the two adjacent teeth. When the liquid in the water outlet channel 13 spurts out from the outlet 132, the first stop flange 20 prevents the liquid from splashing around and guides the liquid, so that the liquid is not prone to random splashing, which protects of the oral cavity of the user.

Furthermore, the first notches 23 are located on longer sides of the end surface of the second end 12 of the main body 10. That is, the first notches 23 are located on sides of the oblong end surface 121 of the main body 10 along the length direction. By such arrangement, even if the outlet 132 is blocked, the liquid flows out in a left direction and a right direction (as shown in FIG. 11) rather than flowing out up or down, which avoids damage to the gums by excessive pressure of the liquid.

Furthermore, since the second end 12 of the main body 10 is configured as the oblate column, the end surface of the second end 12 of the main body 10 is the oblong end surface 121. When the user uses the oral irrigator device 200 to irrigate the teeth, the end surface of the second end 12 of the main body 10 is placed against the surfaces of two adjacent teeth, and the end surface of the second end 12 of the main body 10 forms a certain angle with the surfaces of the two adjacent teeth of the user. In this way, during use, a contact area between the end surface of the second end 12 of the main body 10 and the surfaces of the two adjacent teeth is relatively large.

In some embodiments, the length of the oblong end surface 121 of the main body 10 is not greater than 8 mm. If the length of the oblong end surface 121 is greater than 8 mm, the oblong end surface 121 of the main body may easily touch the gums, which may easily cause damage to the gums. That is, by setting the length of the oblong end surface 121 of the main body 10 being not greater than 8 mm, such as 8 mm, 7 mm, 6 mm, 5 mm, etc., when in use, an outer peripheral side of the oblong end surface 121 of the main body 10 is less likely to touch the gums and is less likely to cause damage to the gums.

Furthermore, the outlet 132 in the embodiment is a long-narrow-shaped hole, and a shape of the along-narrow-shaped hole is matched with the end surface of the second end of the main body 10. Namely, the outlet 132 is a non-circular hole, and a shape of the non-circular hole is matched with the second end of the main body 10. That is, when the end surface of the second end 12 of the main body 10 is configured as the oblong end surface, the outlet 132 is also configured as an oblong outlet, and length and width directions of the oblong outlet 132 are consistent with the length and width directions of the oblong end surface of the second end 12 of the main body 10. Under the same moving distance, more liquid is spurted out of the outlet 132 than that of a circular outlet, so that the cleaning efficiency of the nozzle 100 on the two adjacent teeth is further improved. When the nozzle 100 moves, since the outer sides of the second end 12 of the main body 10 play the guiding role, a shape of the liquid spurting out from the outlet 132 is adapted to a shape of the tooth gap between the two adjacent teeth, so the tooth gap between the two adjacent teeth is cleaned synchronously.

As shown in FIGS. 6-9, in some embodiments, the main body 10 is a linear column. It is understood that the linear column is of a cylindrical structure with a straight central axis, which has a simple structure and is easy to prepare. Optionally, the end surface of the second end 12 of the main body 10 is a flat surface, and the end surface of the second end 12 of the main body 10 is perpendicular or inclined to the straight central axis of the main body 10. Furthermore, in the embodiment, the end surface of the second end 12 of the main body 10 is inclined to the straight central axis of the main body 10. When in use, the end surfaces of the second end 12 of the main body 10 is not likely to completely fit the surfaces of the two adjacent teeth, and the surfaces of the two adjacent teeth of the user are even less likely to block the outlet 132.

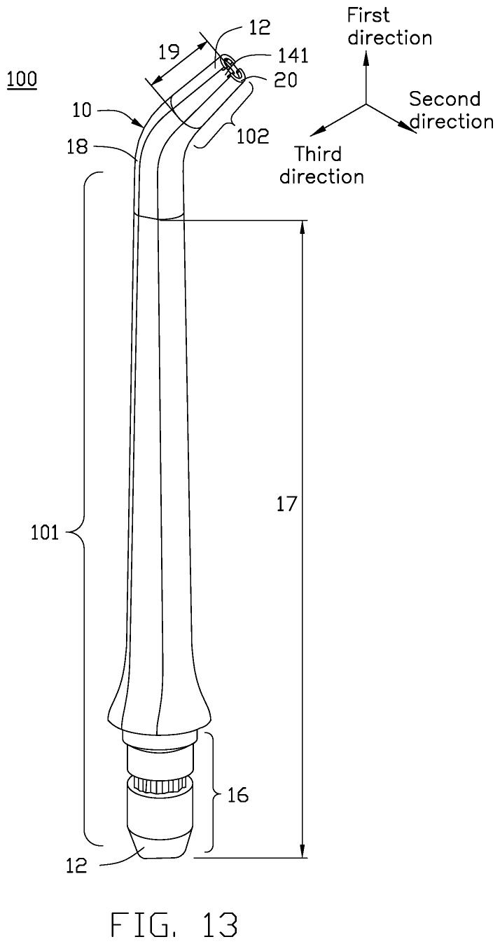

As shown in FIG. 13, in other embodiments of the present disclosure, the main body 10 comprises a bending section 18 disposed between the first end 11 and the second end 12 of the main body 10. In this way, the second end 12 of the main body 10 has a curved arm, so that when using the nozzle 100, the user does not need to significantly adjust a posture of an arm to conveniently clean the oral cavity comprehensively. Furthermore, the main body 10 comprises a first linear column 17 disposed between the bending section 18 and the end surface of the first end 11 of the main body 10. The main body 10 comprises a second linear column 19 disposed between the bending section 18 and the end surface of the second end 12 of the main body. It is understood that the first linear column 17 and the second linear column 19 refer to cylindrical structures whose central axes are straight lines. In the embodiment, the end surface of the second end 12 of the main body 10 is a flat surface, and the end surface of the second end 12 of the main body 10 is perpendicular or inclined to a central axis of the second linear column 19. In one optional embodiment, the end surface of the second end 12 of the main body 10 is inclined to the central axis of the second linear column 19. When in use, the end surface of the second end 12 of the main body 10 is not easy to completely attach to the surfaces of two adjacent teeth, so that the outlet 132 is not easily blocked by the surfaces of the two adjacent teeth.

As shown in FIGS. 13-14, the main body 10 comprises a main body portion 101 and an extension portion 102. The irrigator body 210 defines the first direction, the second direction, and the third direction. The first direction, the second direction, and the third direction are perpendicular to each other. The main body portion 101 extends along the first direction away from the irrigator body 210. The extension portion 102 is connected to one end of the main body portion 101. The first stop flange 20 is connected to one end of the extension portion 102. The extension portion 102 obliquely extends along the second direction away from the main body portion 101 (a boundary between the main body portion 101 and the extension portion 102 is located at a position, where the extension portion 102 starts to obliquely extend toward the second direction, of the extension portion 102). The first stop flange 20 comprises a first side wall 14a and a second side wall 14b disposed opposite to the first side wall 14a. The first side wall 14a and the second side wall 14b are disposed along the third direction. An end surface of a free end of the extension portion 102 (i.e., the end surface of the second end 12 of the main body) intersects the first side wall 14a to define a first intersection edge, and the end surface of the free end of the extension portion 102 intersects the second side wall 14b to define a second intersection edge. At least one of the first intersection edge and the second intersection edge is a straight edge 15.

That is, the first intersection edge of the end surface of the free end of the extension portion 102 and the first side wall 14a is the straight edge 15, or, the second intersection edge of the end surface of the free end of the extension portion 102 and the second side wall 14b is the straight edge 15, or, both of the first intersection edge of the end surface of the free end of the extension portion 102 and the first side wall 14a and the second intersection edge of the end surface of the free end of the extension portion 102 and the second side wall 14b are straight edges 15. By such arrangement, during actual use of the oral irrigator device 200, the end surface of the free end of the extension portion 102 of the nozzle 100 is aligned with the surfaces of the two adjacent teeth of the user. At this time, the end surface of the free end of the extension portion 102 of the nozzle 100 is placed against the tooth gap between the two adjacent teeth through an action of the at least one straight edge 15 on at least one outer edge of the end surface of the free end of the extension portion 102. Compared with a conventional oral irrigator device where an outer peripheral side of a nozzle thereof having a circular arc surface or an elliptical arc surface, the at least one straight edge 15 in the present disclosure positions the nozzle 100 to a certain extent, thereby preventing the nozzle 100 from slipping on the surfaces of the two adjacent teeth to a certain extent and improving the cleaning efficiency and the cleaning comprehensiveness of the nozzle 100 on the teeth.

In some embodiments, at least one of the first side wall 14a and the second side wall 14b of the first stop flange 20 is a flat surface. That is, in actual use, the first side wall 14a is configured to be the flat surface, the second side wall 14b is configured to be the flat surface, or both of the first side wall 14a and the second side wall 14b are flat surfaces. As shown in the drawings of the second embodiment, the first side wall 14a and the second side wall 14b are configured to be the flat surfaces for illustration. The first side wall 14a and the second side wall 14b extend along the second direction and are intersected with the end surface of the free end of the extension portion 102 to form two straight edges 15. In other words, there are at least one flat surface and at least one straight edge 15 on the outer edge of the end surface of the extension portion 102. During the actual use of the nozzle 100, at least one of the first side wall 14a and the second side wall 14b that is the flat surface is placed against the surfaces of the two adjacent teeth, and the at least one straight edge 15 is placed against the tooth gap between the two adjacent teeth. Compared with the conventional oral irrigator device where the outer peripheral side of the nozzle thereof having the circular arc surface or the elliptical arc surface, the at least one of the first side wall 14a and the second side wall 14b that is the flat surface and the at least one straight edge 15 in the embodiment position the nozzle 100 to a certain extent, thereby preventing the nozzle 100 from slipping to a certain extent. When the user moves the nozzle 100, the at least one straight edge 15 slides up and down along the tooth gap between the two adjacent teeth. That is, the at least one straight edge 15 further plays a guiding role, which improves the cleaning efficiency and the cleaning comprehensiveness of the nozzle 100 on the teeth, making the nozzle 100 convenient for the user to use and operate.

In some embodiments, as shown in the drawings of the second embodiment, the first side wall 14a and the second side wall 14b are configured to be the flat surfaces, and the first side wall 14a and the second side wall 14b extend along the second direction and are intersected with the end surface of the free end of the extension portion 102 to form two straight edges 15. The first side wall 14a and the second side wall 14b are the flat surfaces, so there are two straight edges 15 corresponding to the flat surfaces. The first side wall 14a and the second side wall 14b are respectively located on the two opposite sides of the first stop flange 20, and the two straight edges 15 are respectively located on the two opposite sides of the first stop flange 20. When the nozzle 100 moves left and right in the oral cavity, the two straight edges 15 on the two opposite sides of the first stop flange 20 are placed against the tooth gap between the two adjacent teeth, and the first side wall 14a and the second side wall 14b that are corresponding located on the two opposite sides of the first stop flange 20 just abut against the surfaces of the two adjacent teeth. That is, by arrangements of the first side wall 14a, the second side wall 14b, and the two straight edges 15, the first side wall 14a and the second side wall 14b are capable of abutting against the surfaces of the two adjacent teeth at the same time, so that a position of the nozzle 100 is multiply limited, and the nozzle 100 hardly slips during use.

When moving the nozzle 100, straight edges 15 play a guiding role. In particular, the tooth gap between two adjacent teeth is generally linear. When the nozzle 100 moves, the straight edges 15 are aligned with the tooth gap between the two adjacent teeth, which also play a role in adjusting a moving direction thereof.

In some embodiments, the straight edges 15 on two sides of the connecting area 1212 extending along a width direction of the connecting area 1212 are parallel to each other, and a width between the two straight edges 15 is not greater than 4 mm. Optionally, the width between the two straight edges 15 is 2.5-3 mm, such as 2.5 mm, 2.6 mm, 2.7 mm, 2.8 mm, 2.9 mm or 3 mm, etc. It is understood that the width direction of the connecting area 1212 refers to a width direction of the oblong end surface 121 of the main body 10. When the width between the two straight edges 15 is greater than 4 mm, and when the oblong end surface 121 of the main body 10 is placed against one of the two adjacent teeth, the oblong end surface 121 of the main body 10 is easy to interfere with the other one of the two adjacent teeth, thus affecting the use. That is, if the width between the two straight edges 15 is set to be not greater than 4 mm, the end surface of the second end 12 of the main body 10 of the nozzle 100 does not easily interfere with the teeth during use.

In summary, when using the nozzle 100 of the present disclosure to clean the teeth, the outlet 132 is not blocked by the surfaces of the teeth. When the liquid in the water outlet channel 13 spurts out from the outlet 132, the first stop flange 20 limits the liquid, and the liquid is not prone to random splashing. The liquid spurting out from the outlet 132 first enters the first groove 30 and then spurts out from the first notches 23 on the first stop flange 20. During this process, the liquid spreads in the first groove 30 to reduce the pressure, which further prevents the liquid from splashing or damaging the gums, and improves the user experience during use of the nozzle 100.

### Embodiment 3

As shown in FIGS. 15-19, according to the third embodiment of the present disclosure, an oral irrigator device 200 is provided. The oral irrigator device 200 comprises an irrigator body 210 and a nozzle 100. The nozzle 100 is detachably connected to the irrigator body 210 by hand. Optionally, the nozzle 100 is connected to the irrigator body 210 through fastening structures.

Specifically, the irrigator body 210 comprises a pump body disposed in the irrigator body 210, a water storage space, and a water channel (not shown in the drawings). A water inlet of the pump body is communicated with the water outlet space, and a water outlet of the pump body is communicated with the water channel. When the pump body works, a liquid such as water stored in the water storage space is pumped out through the water channel, so that an oral cavity of a user is cleaned.

Furthermore, the nozzle 100 comprises a main body 10, and the main body 10 defines a water outlet channel 13. The water outlet channel 13 comprises a liquid inlet section 134, a transition connecting section 135, and a liquid outlet section 136. The liquid inlet section 134, the transition connecting section 135, and the liquid outlet section 136 are connected in sequence. The liquid outlet section 136 comprises a liquid inlet 1361 and an outlet 132.

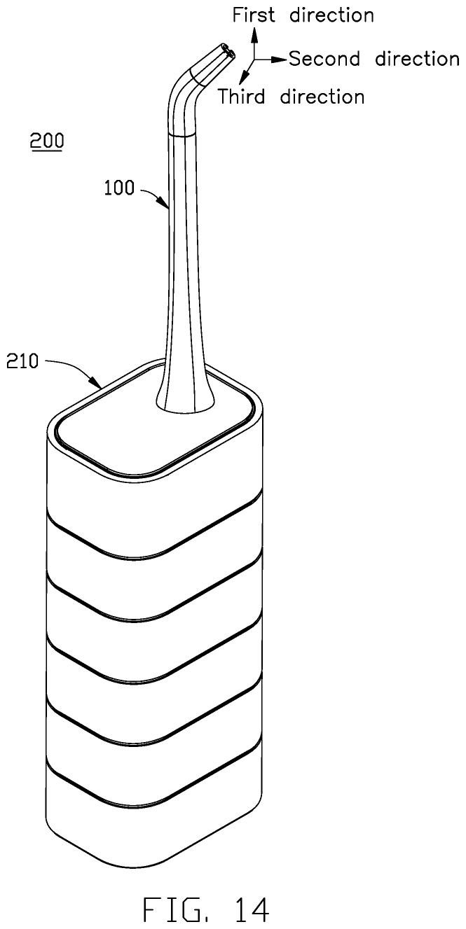

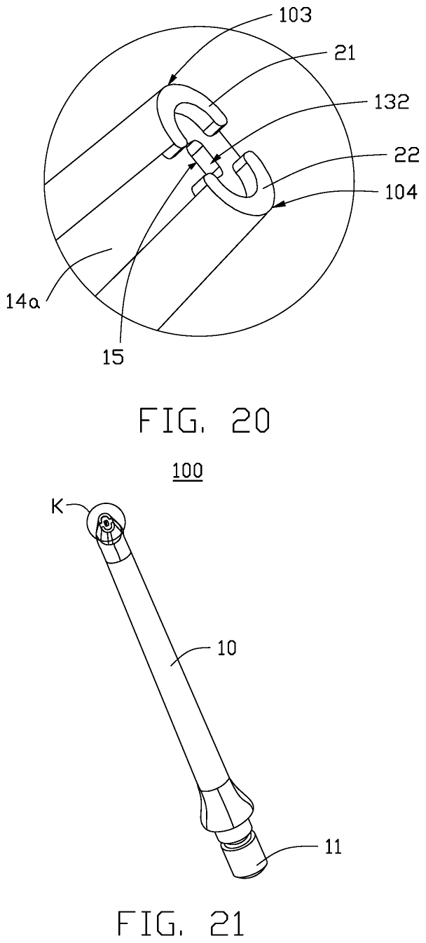

The liquid inlet 1361 is disposed close to the transition connecting section 135, and the outlet 132 is disposed away from the transition connecting section 135. The outlet 132 is defined on an end surface of the main body 10. The end surface of the main body 10 comprises a top portion 103 and a bottom portion 104. When the main body 10 is vertically placed (as shown in FIGS. 16 and 20), a height of the top portion 103 is greater than a height of the bottom portion 104. The liquid outlet section 136 defines an outlet 132. The outlet 132 is slit-shaped and extends from the top portion 103 toward the bottom portion 104.

In actual use, the nozzle 100 is installed on the irrigator body 210, and the water outlet channel 13 is connected to the water channel. When the pump body works, water or other liquids in the water storage space is pumped to the liquid inlet 1361 of the nozzle 100, and then spurts out from the water outlet channel 13 to clean the oral cavity of the user.

When the liquid spurts out from the outlet 132, since the outlet 132 is slit-shaped, a length of the outlet 132 is greater than a width of the outlet 132. Compared with a conventional outlet in another shape (e.g. a circular outlet and a square outlet), when a size of the outlet 132 (i.e., an area of the outlet 132) is same a size of the conventional outlet, the liquid spurts out from the outlet 132 moves a same distance, an area of the teeth irrigated by the liquid spurting out from the outlet 132 is greater than an area of the teeth irrigated by the liquid spurting out from the circular outlet or the square outlet.

Furthermore, the outlet 132 extends along a direction from the top 103 portion to the bottom portion 104 of the end surface of the main body 10 where the outlet 132 is defined. When using the nozzle 100, an extension direction of an irrigating end surface from the bottom portion 104 to the top portion 103 of the end surface of the main body 10 is consistent with an extension direction of the tooth gap between two adjacent teeth. A water column spurting out from the outlet 132 is thinner and flows into the tooth gap between two adjacent teeth more easily, leading to a better irrigating effect. That is, setting the outlet 132 to be slit-shaped not only increases a flow rate and an irrigating intensity of the liquid, but also increases an irrigating area during use of the nozzle 100, taking both the irrigating intensity and an irrigating range into account, and making it easier to inject the liquid spurting out from the nozzle 100 into the tooth gap between two adjacent teeth of the user, thereby bringing better user experience.

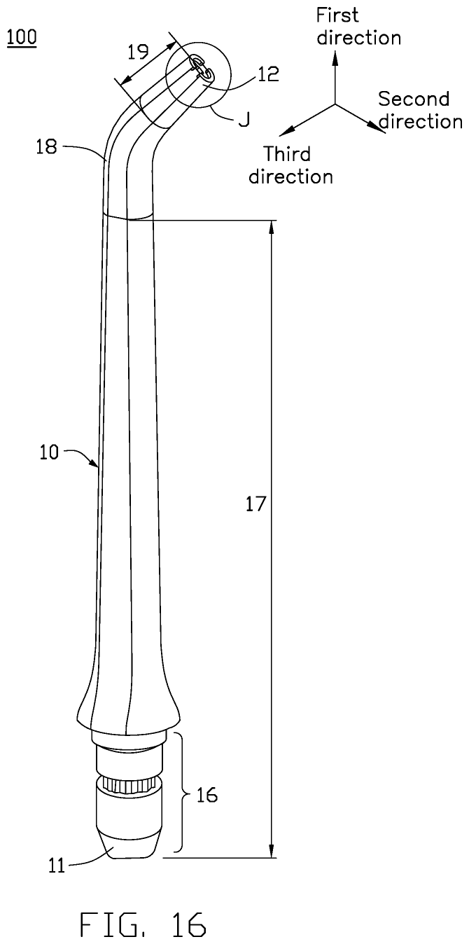

In some embodiments, the main body 10 is columnar, which is selected from a cylinder, a prism, an elliptical column, or a special-shaped column. FIG. 16 and FIG. 18 in the embodiment show a case where the main body 10 is configured as the special-shaped column.

Specifically, the main body 10 comprises a first end 11 and a second end 12. The water outlet channel 13 extends from the first end 11 to the second end 12 of the main body 10, and the liquid outlet section 136 of the water outlet channel 13 is close to the second end 12 of the main body 10. A connecting portion 16 is disposed on the first end 11 of the main body 10. The nozzle 100 is conveniently connected to the irrigator body 210 configured to install the nozzle 100 by hand through the connecting portion 16.

In the embodiment, along the direction from the first end 11 to the second end 12 of the main body 10, areas of cross sections of the main body 10 gradually decrease. It is understood that the cross sections of the main body 10 are cross sections obtained by cutting the main body 10 along the direction perpendicular to the length direction of the main body 10. During a installing process of the nozzle 100, when a force is applied on the nozzle 100 to install the nozzle 100 on the irrigator body 210 of the oral irrigator device 200, since the areas of the cross sections of the main body 10 of the nozzle 100 gradually increase in a direction of the main body toward the irrigator body 210 of the oral irrigator device 200, a side surface of the main body 10 provide a relatively stable acting point for the user, which increases a contact area between the side surface of the main body 10 of the nozzle 100 and a force application part (such as a hand) of the user, and makes it more comfortable to install the nozzle 100.

For instance, a length of the main body 10 is 8-15 mm, such as 8 mm, 10 mm, 12 mm, 14 mm 15 mm, etc. When the length of the main body 10 is less than 8 mm, and the nozzle 100 is installed on the irrigator body 210 of the oral irrigator device 200, during a e process of operating the nozzle 100 by the user, since the main body 10 is relatively short, the main body 10 is easily shielded by the irrigator body 210 of the oral irrigator device 200, which is not convenient for the user to observe and use. When the length of the main body 10 is greater than 15 mm, the length of the main body 10 is relatively long, a flow path of the liquid is relatively long, and the flow rate and the irrigating intensity of the liquid are easily reduced. Meanwhile, the length of the main body 10 is set to be 8-15 mm, which takes a shape of the oral cavity of the human body in to account, enabling the main body 10 to fit to shapes of oral cavities of most human bodies.

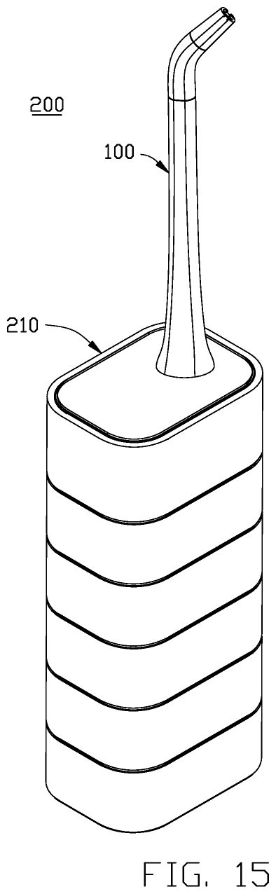

In some embodiments, along a length direction of the water outlet channel 13, areas of cross sections of the liquid inlet section 134 are unchanged, areas of cross sections of the transition connecting section 135 gradually decreases along a direction from the liquid inlet section 134 to the liquid outlet section 136, and an area of a maximum cross section of the liquid outlet section 136 is less than an area of any one of the cross sections of the liquid inlet section 134. The cross sections of the liquid inlet section 134, the cross sections of the transition connecting section 135, and the cross section of the liquid outlet section 136 are cross sections obtained by cutting the liquid inlet section 134, the transition connecting section 135, and the liquid outlet section 136 in a direction perpendicular to the length direction of the water outlet channel 13. In this way, when the liquid enters the liquid inlet section 134, the liquid flows at a relatively stable flow rate, the liquid is not prone to turbulence, and a flow noise of the liquid during the use process is relatively small. After the liquid enters the transition connecting section 135, the pressure and the flow rate of the liquid are gradually increased, so that after the liquid enters the liquid outlet section 136, the liquid spurts out from the outlet 132 at a high flow rate, and the irrigating intensity of the liquid is improved. It is understood that a boundary between the transition connecting section 135 and the liquid inlet section 134 in the embodiment is located at a portion where areas of cross sections thereof are about to decrease. A boundary between the transition connecting section 135 and the liquid outlet section 136 is located at a position thereof where areas of the cross sections thereof are about to increase. For details, referring to a broken-lined frame shown in FIGS. 17 and 18, an upper side of the broken-lined frame is the boundary between the transition connecting section 135 and the liquid outlet section 136, and a lower side of the broken-lined frame is the boundary of the transition connecting section 135 and the liquid inlet section 134.

Furthermore, at least one of the liquid inlet section 134, the transition connecting section 135, and the liquid outlet section 136 is a straight section. It is understood that the straight section refers to one of the liquid inlet section 134, the transition connecting section 135, and the liquid outlet section in which a central axis thereof is straight. By setting the at least one of the liquid inlet section 134, the transition connecting section 135 and the liquid outlet section 136 as the straight section, energy loss of the liquid is reduced, the liquid is not prone to turbulence in the water outlet channel 13, and the irrigating intensity of liquid spurting out is improved.

Optionally, the cross sections of the liquid inlet section 134, the cross sections of the transition connecting section 135 are circular, square, elliptical, triangular or other special shapes, which are all included in the protection scope of the present disclosure, as long as they are modifications made under the concept of the present disclosure. The drawings in the embodiment show a situation where the cross sections of the liquid inlet section 134 and the cross sections of the transition connecting section 135 are circular.

Furthermore, the areas of the cross sections of the liquid outlet section 136 in the embodiment gradually increase along a direction from the liquid inlet 1361 to the outlet 132, and a ratio of the area of the liquid inlet 1361 to the area of the outlet 132 is 0.45-0.8, such as 0.45, 0.50, 0.55, 0.60, 0.65, 0.70, 0.75, 0.80, etc. By such arrangement, when the liquid enters the liquid outlet section 136, the liquid diffuses after spurting out of the outlet 132, which further increases the irrigating area defined by the liquid. In addition, diffusion of the liquid consumes energy, and if the ratio of the area of the liquid inlet 1361 to the area of the outlet 132 is less than 0.45, the liquid diffuses in a large area, which greatly reduce the irrigating intensity of the liquid spurting out of the outlet 132. If the ratio of the area of the liquid inlet 1361 to the area of the outlet 132 is greater than 0.8, a diffusion angle of the liquid is not enough, which affect the irrigating area defined by the liquid. Therefore, by setting the areas of the cross sections of the liquid outlet section 136 of the nozzle 100 to gradually increase along a direction from the liquid inlet 1361 to the outlet 132, and by setting the ratio of the area of the liquid inlet 1361 to the area of the outlet 132 bring 0.45-0.8, the irrigating intensity of the liquid is ensured, and the irrigating area defined by the liquid is ensured.

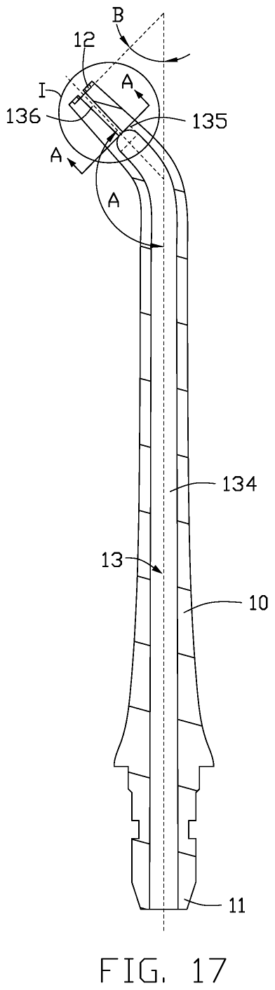

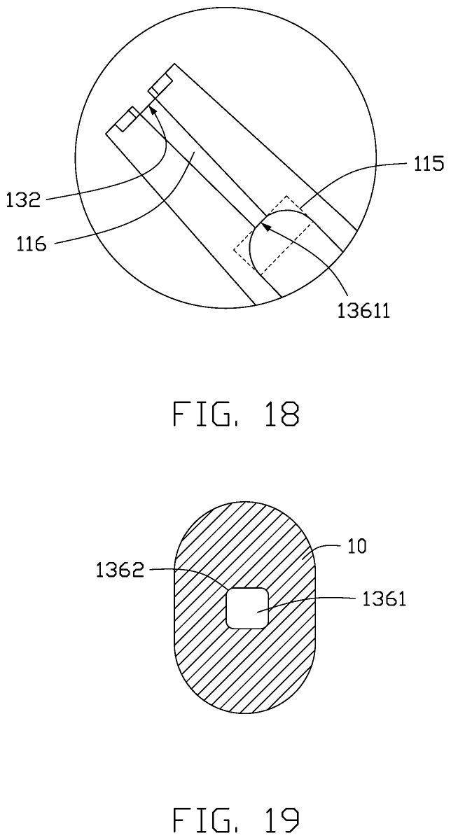

As shown in FIGS. 19-22, in some embodiments, the liquid inlet 1361 is a square opening, and the outlet 132 is a rectangular opening. Along the direction from the liquid inlet 1361 to the outlet 132, a width of the liquid outlet section 136 does not change, and a length of the liquid outlet section 136 gradually increases. The liquid inlet 1361 is configured as the square opening. In this way, the liquid flows into the liquid outlet section 136 evenly and smoothly along four sides of the liquid inlet 1361. The liquid is not prone to turbulence, thereby ensuring that the liquid flows into the liquid outlet section 136, ensuring the flow rate of the liquid in the liquid outlet section 136, and further ensuring the irrigating intensity of the liquid. Moreover, the width of the liquid outlet section 136 does not change and the length of the liquid outlet section 136 gradually increases along the direction from the liquid inlet 1361 to the outlet 132, so that the liquid diffuses smoothly in the liquid outlet section 136, which effectively balances the irrigating intensity and the irrigating area of the liquid.

In addition, by configuring the liquid inlet 1361 as the square opening, configuring the outlet 132 as the rectangular opening, and configuring the width of the liquid outlet section 136 being unchanged and the length of the liquid outlet section 136 being gradually increased along the direction from the liquid inlet 1361 to the outlet 132, when the nozzle 100 is formed by mold processing, it is convenient for the nozzle 100 to be demolded, which improves a yield of the nozzle 100 during a production process. Of course, in other embodiments of the present disclosure, the liquid inlet 1361 may be a circle, a triangle, a regular pentagon or other regular polygons, which are all within the protection scope of the present disclosure as long as there are modifications made under the concept of the present disclosure.

Furthermore, in the embodiment, corners of the liquid inlet 1361 and/or corners of the outlet 132 are second rounded corners 1362. That is, the corners of the liquid inlet 1361 are the second rounded corners 1362, the corners of the outlet 132 are the second rounded corner 1362, or the corners of the liquid inlet 1361 and the corners of outlet 132 are the second rounded corners 1362 at the same time. By such arrangements, smoothness of an inner surfaces of the liquid inlet 1361 and the outlet 132 is improved, a resistance of an inner wall of the liquid outlet section 136 to the liquid is reduced, the liquid flows smoother, the energy loss of the liquid is reduced, and the irrigating intensity of liquid to the oral cavity is improved. Furthermore, the length of the liquid outlet section 136 is 5-7 mm, such as 5 mm, 6 mm, 7 mm, etc. Optionally, the length of the liquid outlet section 136 is 6.1 mm. It is understood that the length of the liquid outlet section 136 affects the irrigating intensity and the irrigating area of the liquid. Specifically, if the length of the liquid outlet section 136 is less than 5 mm, a length change of the outlet 132 is not large enough (that is, the length and width of the outlet 132 are relatively close), and an irrigating range of the nozzle 100 during movement is not large enough. When the length of the liquid outlet section 136 is greater than 7 mm, the length of the liquid outlet section 136 is relatively long, the flow path of the liquid is relatively long, and the energy loss of the liquid is relatively large, which easily reduces the flow rate and the irrigating intensity of the liquid spurting out from the outlet 132. In other words, in the embodiment, by configuring the length of the liquid outlet section 136 to 5-7 mm, the irrigating intensity and the irrigating area of the liquid spurting out from the nozzle 100 are balanced.

In some embodiments, an increase rate of the areas of the cross sections of the transition section 135 is greater than a decrease rate of the areas of the cross sections of the liquid outlet section 136. It is understood that the increase rate of the areas of the cross sections of the transition connecting section 135 and the decrease rate of the areas of the cross sections of the liquid outlet section 136 refer to a change rate of the areas of the cross sections of the transition connecting section 135 per unit length and a change rate of the areas of the cross sections of the liquid outlet section 136 per unit length. In this way, when the liquid enters the liquid outlet section 136 from the transition connecting section 135, the liquid generates a cavitation effect due to a sharp reduction of a flow space thereof, which further increases cleaning ability of the liquid spurting out. It is understood that the cavitation effect refers to a dynamic process of growth and collapse of micro-gas core cavitation bubbles in the liquid that vibrate under an action of sound waves. When the sound waves reach a certain value, the micro-gas core cavitation bubbles grow or collapse. Specifically, when ultrasonic waves act on the liquid, a large number of tiny bubbles are generated. If energy of the ultrasonic waves is high enough, a phenomenon of ultrasonic cavitation occurs. The tiny bubbles (i.e., cavitation bubbles) in the liquid vibrate, grow, and continue to grow under the action of the ultrasonic waves to collect sound field energy. When the sound field energy reaches a certain threshold, the cavitation bubbles collapse and fade rapidly to release huge energy, so as to effectively clean the oral cavity.

Furthermore, an area of an opening at one end of the transition connecting section 135 close to the liquid inlet section 134 is 3.12-9.62 mm², such as 3.12 mm², 5 mm², 7 mm², 8 mm², 9.62 mm², etc. Optionally, the opening at the one end of the transition connection section 135 close to the liquid inlet section 134 is a circular opening. A diameter of the opening at the one end of the transition connection section 135 close to the liquid inlet section 134 is 2-3.5 mm, such as 2 mm, 2.5 mm, 3 mm, 3.5 mm, etc. The length of the transition connection section 135 is 1-1.5 mm, such as 1 mm, 1.2 mm, 1.3 mm, 1.4 mm, 1.5 mm, etc. In this way, when the cavitation effect occurs in the liquid, the cleaning ability of the nozzle 100 on the oral cavity is improved.

Optionally, a ratio of the length of the transition connecting section 135 to the length of the liquid outlet section 136 is ⅙ to 3/10, such as ⅙, ⅕, 3/10, etc. By such arrangement, the cavitation effect of the liquid in the water outlet channel 13 is improved, thereby improving the cleaning ability of the nozzle 100 on the oral cavity.

In some embodiments, the main body 10 is a linear column. It is understood that the linear column is of a cylindrical structure with a straight central axis. During the actual processing, the water outlet channel 13 is extended from the first end 11 to the second end 12 of the main body 10, so that the water outlet channel 13 is a linear channel. Therefore, when the liquid flows in the water outlet channel 13, the turbulence is not easily generated, and the energy loss of the liquid is small. In addition, the water outlet channel 13 that is linear is easier to process and produce than a curved water outlet channel, which improves the yield of the nozzle 100 during the production process and reduces production cost of the nozzle 100.

As shown in FIGS. 16-17, in other embodiments of the present disclosure, the main body 10 is not linear. Specifically, the main body 10 comprises a bending section 18 disposed between the first end 11 and the second end 12 of the main body 10. By disposing the bending section on a portion of the main body close to the second end 12 of the main body 10, the second end 12 of the main body deflects and bends. In this way, the second end 12 of the main body 10 has a curved arm, so that when using the nozzle 100, the user does not need to significantly adjust a posture of an arm to conveniently clean the oral cavity comprehensively.

It is understood that the bending section 18 is structure enabling the main body 10 to bend at the second end 12, and a specific length of the bending section 18 is not limited thereto, as long as the bending section 18 deflects the second end 12 of the main body. 10.

Furthermore, the main body 10 comprises a first linear column 17 disposed between the bending section 18 and the end surface of the first end 11 of the main body 10. The main body 10 comprises a second linear column 19 disposed between the bending section 18 and the end surface of the second end 12 of the main body. An included angle A between the first linear column 17 and the second linear column 19 is 135-60 degrees, such as 135 degrees, 140 degrees, 145 degrees, 150 degrees, 155 degrees, 160 degrees, etc. It is understood that the first linear column 17 and the second linear column 19 refer to cylindrical structures whose central axes are straight lines. The included angle between the first linear column 17 and the second linear column 19 refers to an angle between a central axis of the first linear column 17 and a central axis of the second linear column 19. Taking sizes of the oral cavity, teeth, gums, and lips into account, by setting the included angle A between the first linear column 17 and the second linear column 19 to be 135-160 degrees, it is more suitable for the nozzle 100 to rotate and move in the oral cavity, which improves the user experience of the nozzle 100.

Furthermore, the end surface of the second end 12 of the main body 10 is a flat surface. The outlet 132 is defined on the end surface of the second end 12 of the main body 10. When the nozzle 100 is placed upright in a horizontal plane, an included angle B between the end surface of the second end 12 of the main body 10 and a vertical plane is 20-60 degrees, such as 20 degrees, 30 degrees, 40 degrees, 50 degrees, 60 degrees, etc. In this way, the outlet is less likely to be blocked during use (that is, the outlet 132 is not easily blocked by the two adjacent teeth, leading to reduction of the irrigating area of block of the liquid).

As shown in FIG. 22, in some embodiments, a first stop flange 20 is protruded from an outer periphery of the end surface of the second end 12 of the main body 10. The first stop flange 20 extends along the outer periphery of the end surface of the second end 12 of the main body 10. The first stop flange 20 comprises a first arc-shaped section 21 and a second arc-shaped section 22. Ends of the first arc-shaped section 21 is spaced apart from the ends of the second arc-shaped section 22 to define first notches 23. When the end surface of second end 12 of the main body 10 is placed against the surfaces of the two adjacent teeth, the liquid in the water outlet channel 13 spurts out from the outlet 132, then the liquid passes through the first notches 23, and the liquid irrigates the two adjacent teeth or the gums of the user. When using the nozzle 100, the user is able to directly place the second end 12 of the nozzle 100 on the two adjacent teeth or the gums to be irrigated. That is, a depth of the first notches 23 ensures that the outlet 132 does not directly in contact with the two adjacent teeth and the gums of the user, thereby preventing the outlet 132 from being blocked.

Furthermore, the ends of the first arc-shaped section 21 and/or the ends of the second arc-shaped section 22 define first rounded corners 201. That is, the ends of the first arc-shaped section 21 define the first rounded corners 201, the ends of the second arc-shaped section 22 define first rounded corners 201, or the ends of the first arc-shaped section 21 and the ends of the second arc-shaped section 22 define the first rounded corners 201. Through the first rounded corners 201, on the one hand, the ends of the first arc-shaped section 21 and the ends of the second arc-shaped section 22 are prevented from scratching the gums; on the other hand, the arrangements of the first rounded corners 201 also play a certain guiding role for the liquid spurting out from the first notches 23 to avoid turbulence of the liquid.

As shown in FIGS. 16, 20, and 22, in some embodiments, the nozzle 100 defines a first direction, a second direction, and a third direction. The first direction, the second direction, and the third direction are perpendicular to each other. T

A portion of the main body 10 disposed between the bending section 18 and the end surface of the first end 11 extends along the first direction and forms the first linear column 17. A portion of the main body 10 disposed between the bending section 18 and the end surface of the second end 12 extends obliquely along the second direction and forms the second linear column 19, The second linear column 19 comprises a first side wall 14a and a second side wall 14b disposed opposite to the first side wall 14a. The first side wall 14a and the second side wall 14b are disposed along the third direction. The end surface of the second end 12 of the main body intersects the first side wall 14a to define a first intersection edge, and the end surface of the second end 12 of the main body intersects the second side wall 14b to define a second intersection edge. At least one of the first intersection edge and the second intersection edge is a straight edge 15.

An extension direction of the outlet 132 is consistent with an extension direction of the at least one straight edge 15. That is, the first intersection edge of the end surface of the second linear column 19 (i.e., the end surface of the second end 12 of the main body 10) and the first side wall 14a is the straight edge 15, or, the second intersection edge of the end surface of the second linear column 19 and the second side wall 14b is the straight edge 15, or, both of the first intersection edge and the second intersection edge are straight edges 15. By such arrangement, during actual use of the oral irrigator device 200, the second end 12 of the nozzle 100 is aligned with the surfaces of the two adjacent teeth of the user. At this time, the second end of the nozzle 100 is placed against the tooth gap between the two adjacent teeth through an action of the at least one straight edge 15 on at least one outer edge of the end surface of the second end 12 of the main body 10. Compared with a conventional oral irrigator device where an outer peripheral side of a nozzle thereof having a circular arc surface or an elliptical arc surface, the at least one straight edge 15 defined on the end surface of the second end 12 of the main body 10 positions the nozzle 100 to a certain extent, thereby preventing the nozzle 100 from slipping on the surfaces of the two adjacent teeth to a certain extent and improving the cleaning efficiency and the cleaning comprehensiveness of the nozzle 100 on the teeth.

In some embodiments, at least one of the first side wall 14a and the second side wall 14b of the second linear column 19 is a flat surface. That is, in actual use, the first side wall 14a is configured to be the flat surface, the second side wall 14b is configured to be the flat surface, or both of the first side wall 14a and the second side wall 14b are flat surfaces. In other words, there are at least one flat surface and at least one straight edge 15 on the outer edge of the end surface of the second end 12 of the main body. During the actual use of the nozzle 100, at least one of the first side wall 14a and the second side wall 14b that is the flat surface is placed against the surfaces of the two adjacent teeth, and the at least one straight edge 15 is placed against the gap between the two adjacent teeth. Compared with the conventional oral irrigator device where the outer peripheral side of the nozzle thereof having the circular arc surface or the elliptical arc surface, the at least one of the first side wall 14a and the second side wall 14b that is the flat surface and the at least one straight edge 15 in the embodiment position the nozzle 100 to a certain extent, thereby preventing the nozzle 100 from slipping to a certain extent. When the user moves the nozzle 100, the at least one straight edge 15 slides up and down along the tooth gap between the two adjacent teeth. That is, the at least one straight edge 15 further plays a guiding role, which improves the cleaning efficiency and the cleaning comprehensiveness of the nozzle 100 on the teeth, making the nozzle 100 convenient for the user to use and operate.

In some embodiments, as shown in the drawings of the second embodiment, the first side wall 14a and the second side wall 14b are configured to be the flat surfaces, and the first side wall 14a and the second side wall 14b extend along the second direction and are intersected with the end surface of the free end of the extension portion 102 to form the straight edges 15. The first side wall 14a and the second side wall 14b are the flat surfaces, so there are two straight edges 15 corresponding to the flat surfaces. The first side wall 14a and the second side wall 14b are respectively located on the two opposite sides of the second linear column 19, and the two straight edges 15 are respectively located on the two opposite sides of the second linear column 19. When the nozzle 100 moves left and right in the oral cavity, the two straight edges 15 on the two opposite sides of the second linear column 19 are placed against the tooth gap between the two adjacent teeth, and the first side wall 14a and the second side wall 14b that are corresponding located on the two opposite sides of the second linear column 19 just abut against the surfaces of the two adjacent teeth. That is, by arrangements of the two straight edges 15, and by configuring the first side wall 14a and the second side wall 14b as the flat surfaces, the first side wall 14a and the second side wall 14b are capable of abutting against the surfaces of the two adjacent teeth at the same time, so that a position of the nozzle 100 is multiply limited, and the nozzle 100 hardly slips during use.

Table 1 shows the pressure of the liquid spurting out from the outlet 132 of the nozzle 100 in four specific implements. The pressure of the liquid spurting out from the outlet 132 refers to data, obtained by a water pressure tester, of the liquid spurting form the outlet to the water pressure tester, when the nozzle 100 is installed on the irrigator body 210 to form the oral irrigator device 200 and the pump body thereof works at a frequency of 1600 HZ. The water pressure tester is a common water pressure tester on the market. The water pressure tester comprises a sensing unit sensing a water pressure and a display unit. When the liquid impacts on the sensing unit, the sensing unit senses the pressure and the data thereof is displayed through the display unit.

TABLE 1

| | | | | Length | | |
|---|---|---|---|---|---|---|
| | Length | | | of the | | |
| | of the | Length | Width | water | | |
| | liquid | of the | of the | outlet | Maximum | Minimum |
| | inlet | outlet | outlet | section | pressure | pressure |
| Implement | (mm) | (mm) | (mm) | (mm) | (*10*Mpa) | (*10*Mpa) |
| 1 | 0.40 | 0.91 | 0.51 | 5.60 | 5.6 | 1.7 |
| 2 | 0.40 | 1.01 | 0.61 | 6.01 | 5.2 | 1.2 |
| 3 | 0.45 | 0.76 | 0.56 | 6.02 | 4.4 | 1.3 |
| 4 | 0.55 | 0.81 | 0.55 | 6.14 | 6.1 | 0.9 |

According to the above implements, it is noted that the nozzle 100 in the embodiment not only increases the flow rate and the irrigating intensity of the liquid, but also increases the irrigating area during use of the nozzle 100, which balances the irrigating intensity and the irrigating range and bring a user experience to the user.

### Embodiment 4

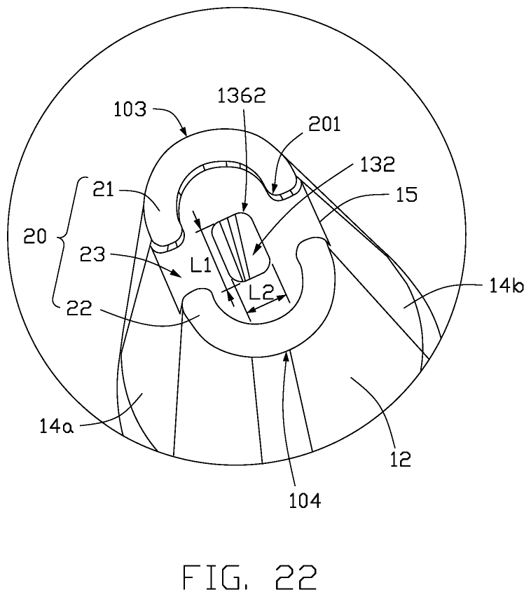

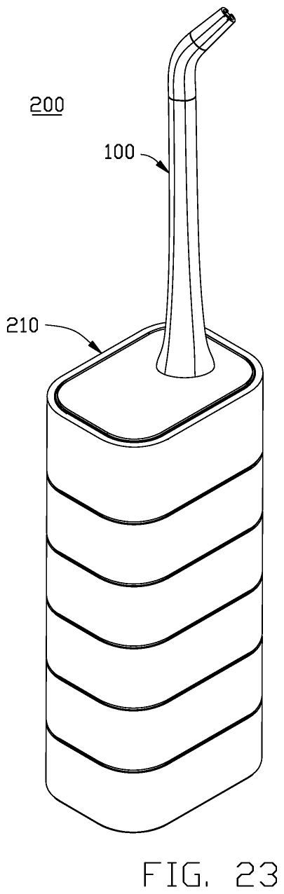

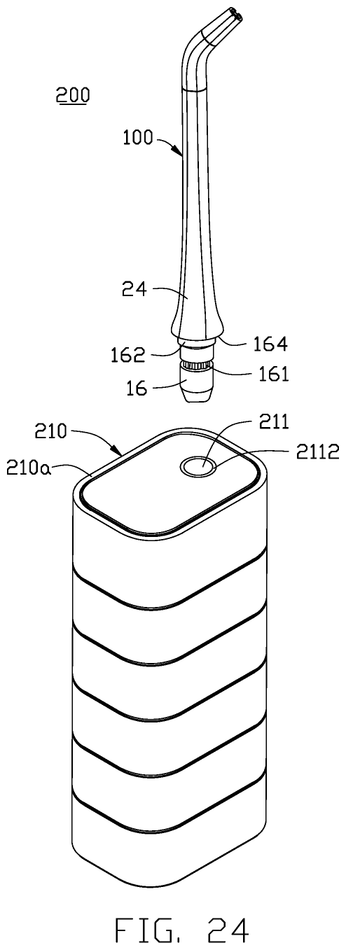

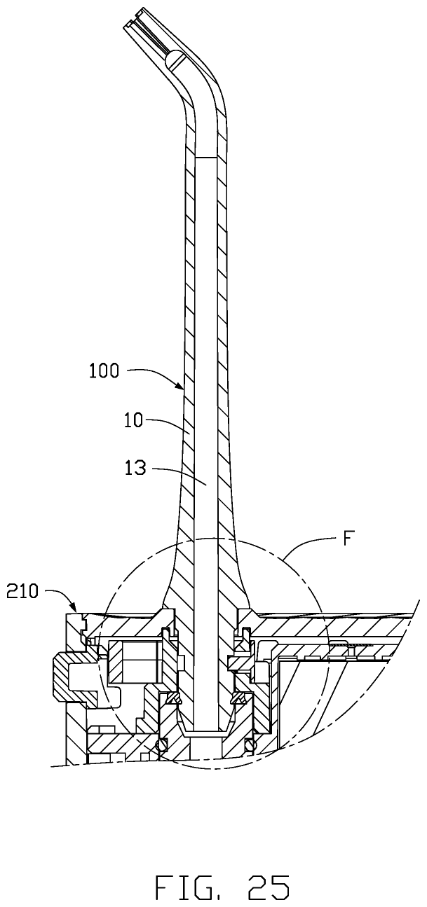

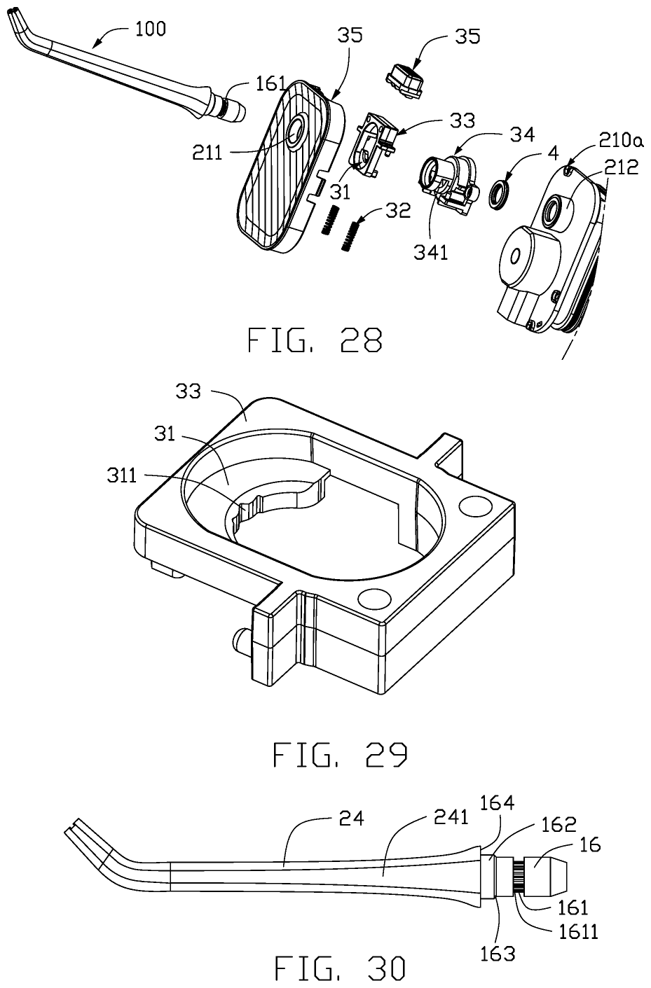

As shown in FIGS. 23-33, according to the fourth embodiment of the present disclosure, an oral irrigator device 200 is provided. The oral irrigator device 200 comprises an irrigator body 210 and nozzle 100. The nozzle 100 is connected to the irrigator body. Specifically, as shown in FIGS. 23-30, the oral irrigator device 200 comprises the nozzle 100, the irrigator body 210 and a clamping assembly 3. An inserting hole 211 is defined on a housing 210a of the irrigator body 210. The nozzle 100 comprises a main body 10 and a water outlet channel 13 defined in the main body 10. The main body 10 comprises a connecting portion 16, an abutting portion 162, and an outflow section 24. The connecting portion 16, the abutting portion 162, and the outflow section 24 are connected in sequence. The connecting portion 16 and the abutting portion 162 are inserted into the irrigator body 210 from the inserting hole 211. The outflow section is exposed out of the irrigator body 210. The abutting portion 162 is matched with the inserting hole 211. A gap is defined between an outer peripheral wall of the abutting portion 162 and an inner peripheral wall of the inserting hole 211. A clamping groove 161 is defined in the connecting portion 16. A portion, close to the abutting portion 162, of the outflow section 24 extends outwards in a radial direction of the inserting hole 211 to form a second stop flange 164. The second stop flange 164 abuts against an outer end surface of the inserting hole 211. The clamping assembly 3 comprises a clamping piece 31 and elastic pieces 32. The elastic pieces 32 are configured to connect the clamping assembly 3 to the irrigator body 210. The clamping piece 31 is engaged with the clamping groove 161 to stop movement of the nozzle 100 along an axial direction of the inserting hole 211. When impacted by an external force, the abutting portion 162, the connecting portion 16, and the second stopping flange 164 together overcome elastic forces of the elastic pieces 32, and the second stopping flange 164 slides a certain distance along the outer end surface 2112 of the inserting hole and drives the abutting portion 162 and the connecting portion 16 to move. The outflow section 24 comprises the main body portion and the extension portion in Embodiment 2 and Embodiment 3.

The inserting hole 211 is defined on the housing 210a of the irrigator body 210, and the nozzle 100 is fixed in the inserting hole 211. It is understood that when the oral irrigator device 200 falls, a portion of the nozzle 100 located outside the inserting hole 211 is impacted by the external force, and at this time, a portion of the nozzle 100 is fixed in the inserting hole 211, the portion of the nozzle 100 fixed in the inserting hole 211 presses against the inner peripheral wall 2111 of the inserting hole under impact of the portion of the nozzle 100 located outside the inserting hole 211, so that a joint between the nozzle 100 and the housing 210a of the irrigator body 210 is a stress concentration portion, that is, the joint between the nozzle 100 and the housing 210a of the body 210 is prone to breakage. For the embodiment, the nozzle 100 comprises the connecting portion 16, the abutting portion 162, and the outflow section 24 that are connected in sequence, the connecting portion 16 and the abutting portion 162 extend in sequence and are fixed in the inserting hole 211, and the outflow section 24 is exposed outside the housing 210a, so that the abutting portion 162 is located at the joint of the nozzle 100 and the housing 210a of the irrigator body 210. That is, the abutting portion 162 is most prone to breakage.

Firstly, when the oral irrigator device 200 falls, the outflow section 24 is located on the outside of the irrigator body 210 and is impacted by the external force. First, since the portion, close to the abutting portion 162, of the outflow section 24 extends outwards in the radial direction of the inserting hole 211 to form the second stop flange 164, and the second stop flange 164 abuts against the outer end surface of the inserting hole 211. The second stop flange 164 presses the outer end surface of the inserting hole 211 and slides for a certain distance along the outer end surface of the inserting hole 211, so as to decompose an extrusion force generated between the outer peripheral wall of the abutting portion 162 and the inner peripheral wall 2111 of the inserting hole 211, thereby reducing a probability of breakage at the abutting portion 162 and improving anti-falling capability of the nozzle 100.

Secondly, when the outflow section 24 is impacted by the external force, the second stop flange 164 slides to drive the abutting portion 162 to move. Since there is the gap between the abutting portion 162 and the inner peripheral wall 2111 of the inserting hole, the abutting portion 162 does not directly press the inner peripheral wall 2111 of the inserting hole. Namely, the gap between the abutting portion 162 and the inner peripheral wall 2111 of the inserting hole plays a buffering role between the abutting portion 162 and the inner peripheral wall 2111 of the inserting hole, thereby further reducing the probability of breakage at the abutting portion 162.

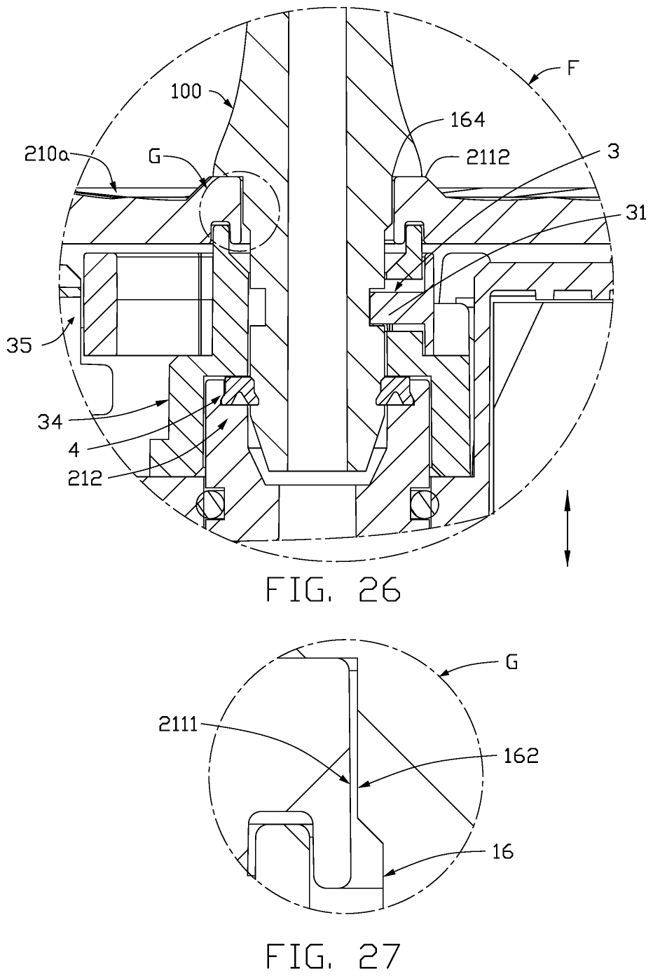

Finally, since the connecting portion 16 defines the clamping groove 161, the clamping piece 31 is connected to the irrigator body 210 through the elastic pieces 32, and the clamping piece 31 is configured to extend into the clamping groove 161 to limit the movement of the nozzle 100 along the axial direction of the inserting hole 211 (the top-bottom direction shown in FIG. 26). When the outflow section 24 is impacted by the external force, the second stop flange 164 slides to drive the connecting portion 16 to move, and the connecting portion 16 has a tendency to press against the inner peripheral wall 2111 of the inserting hole 211. The clamping piece 31 is engaged with and abuts against the clamping groove 161, and the clamping piece 31 is connected to the irrigator body 210 through the elastic pieces 32, so the connecting portion 16 compresses the clamping piece 31. Under compression of the connecting portion 16, the clamping piece 31 compresses the elastic pieces 32. Therefore, the clamping piece 31 and the elastic pieces 32 also counteract a portion of the external force impacting the connecting portion 16 to buffer the connecting portion 16 and the inner peripheral wall 2111 of the inserting hole, thereby further reducing the impact of the connecting portion 16, the abutting portion 162, and the second stop flange 164, and reducing the probability of breakage at the abutting portion 162.

In summary, in the embodiment of the present disclosure, the abutting portion 162 and the connecting portion 16 are not prone to breakage. That is, the joint between the nozzle 100 and the housing 210a of the irrigator body 210 is not prone to breakage, so that anti-breaking capability of the oral irrigator device 200 is good.

It should be noted that, since the second stop flange 164 abuts against the outer end surface 2112 of the inserting hole, when the nozzle 100 is fixed in the inserting hole 211, the abutting portion 162 and the connecting portion 16 insert into the inserting hole 211. At this time, the second stop flange 164 abuts against the outer end surface 2112 of the inserting hole 211 to limit the outflow section 24, thereby preventing the outflow section 24 from inserting into the inserting hole 211. Therefore, the second stop flange 164 not only reduces the probability of breakage at the abutting portion 162, but also plays a limiting role to facilitate the user to install the nozzle 100.

It should be noted that the gap is defined between the abutting portion 162 and the inner peripheral wall 2111 of the inserting hole, so that the connecting portion 16 and the abutting portion 162 are conveniently inserted into the inserting hole 211, thereby facilitating the user to quickly fix the nozzle 100 on the housing 210a. In addition, the clamping groove 161 is matched with the clamping assembly, so that on one hand, the probability of breakage of the abutting portion 162 is reduced, and on the other hand, when the nozzle 100 ejects the liquid, the connecting portion 16 and the abutting portion 162 of the nozzle 100 are not separated from the inserting hole 211 under an impact force of the liquid. It should also be noted that the nozzle 100 is detachable. Specifically, the clamping piece 31 is movable along the radial direction of the inserting hole 211 under extension and retraction of the elastic pieces 32, and when the nozzle 100 needs to be fixed in the inserting hole 211, the clamping piece 31 is clamped into the clamping groove 161, and when the nozzle 100 needs to be detached, the clamping piece 31 is separated from the clamping groove 161.

Furthermore, the outflow section 24 of the nozzle 100 is exposed outside the housing 210a, which facilitates a dentist to hold the housing 210a and align a free end of the outflow section 24 (an upper end of the nozzle 100 shown in FIG. 23) with two adjacent teeth of a patient. Of course, in order to enable the oral irrigator device 200 to be applied in different scenarios, the outflow section 24 may be manufactured into different structures, which is not specifically limited thereto. For instance, the outflow section 24 may be straight, thereby facilitating the dentist to irrigate two adjacent front teeth of the patient. Alternatively, the outflow section 24 is bent, so that the dentist aligns the free end of the outflow section 24 against two adjacent lateral teeth of the patient.

In order to improve a structural strength of the abutting portion 162, an outer diameter of the abutting portion 162 is greater than an outer diameter of the connecting portion 16. Since the outer diameter of the abutting portion 162 is greater than the outer diameter of the connecting portion 16, the structural strength of the abutting portion 162 is increased, thereby reducing the probability of breakage at the abutting portion 162. Meanwhile, the connecting portion 16 and the abutting portion 162 are sequentially inserted and fixed in the inserting hole 211 of the irrigator body 210, and the outer diameter of the connecting portion 16 is less than the outer diameter of the abutting portion 162, so that a gap between the connecting portion 16 and the inner peripheral wall 2111 of the inserting hole 211 is larger, and the connecting portion 16 is smoothly inserted into the inserting hole 211. Therefore, the connecting portion 16 and the abutting portion 162 are smoothly installed in the inserting hole 211, thereby facilitating quick fixing of the nozzle 100 on the housing 210a.

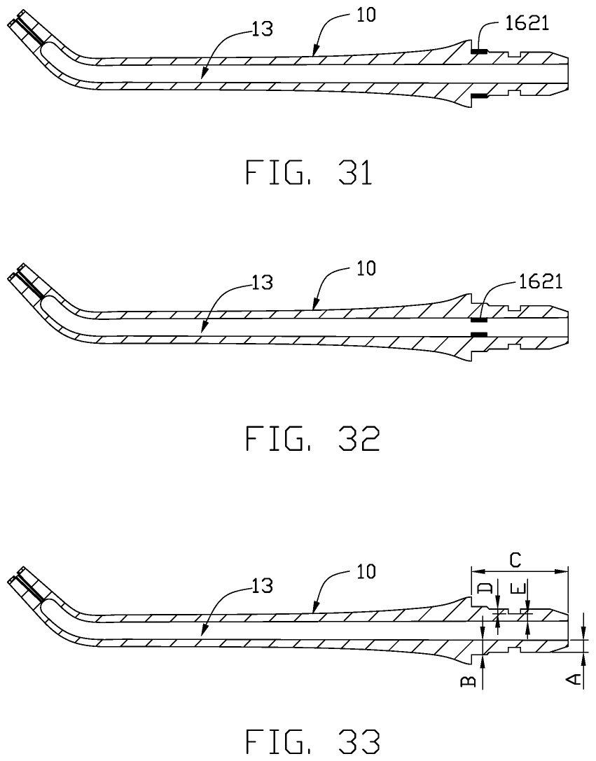

In order to further improve the structural strength of the abutting portion 162, the present disclosure further improves the abutting portion 162. Specifically, in some embodiments, as shown in FIG. 31, a reinforcing ring 1621 is sleeved on the outer peripheral wall of the abutting portion 162. On the one hand, the reinforcing ring 1621 limits the abutting portion 162, thereby reinforcing the structural strength of the abutting portion 162. On the other hand, when the nozzle 100 is installed in the inserting hole 211, since the reinforcing ring 1621 is sleeved on the outer peripheral wall of the abutting portion 162, the abutting portion 162 does not directly abut against the inner peripheral wall 2111 of the inserting hole 211, and the reinforcing ring 1621 directly abuts against the inner peripheral wall 2111 of the inserting hole 211. Further, since the reinforcing ring 1621 itself has a certain structural strength, when the oral irrigator device 200 falls, the reinforcing ring 1621 first presses against the inner peripheral wall 2111 of the inserting hole 211, thereby reducing the probability of breakage at the abutting portion 162.

It should be noted that the reinforcing ring 1621 is sleeved on the abutting portion 162. For instance, the inner peripheral wall of the reinforcing ring 1621 is bonded to the outer peripheral wall of the abutting portion 162 to fix the reinforcing ring 1621 on the abutting portion 162. Alternatively, a mounting groove (not shown in the drawings) is defined on the abutting portion 162, and the reinforcing ring 1621 is embedded in the mounting groove, thereby fixing the reinforcing ring 1621 on the abutting pa 162. Of course, there are other connection methods between the reinforcing ring 1621 and the abutting portion 162, which is not specifically limited thereto.

In other embodiments, as shown in FIG. 32, a reinforcing ring 1621 is disposed on the inner peripheral wall of the abutting portion 162. The reinforcing ring 1621 supports the abutting portion 162 in the water outlet channel 13. When the oral irrigator device 200 falls, the outer peripheral wall of the abutting portion 162 presses against the inner peripheral wall 2111 of the inserting hole, and the abutting portion 162 is subject to a pressure toward an interior thereof. At this time, the reinforcing ring 1621 supports the abutting portion 162 in the water outlet channel 13, thereby preventing the abutting portion 162 from being crushed.

Furthermore, the reinforcing ring 1621 may a plastic reinforcing ring 1621 or a metal reinforcing ring 1621, etc., which is not specifically limited thereto. Since the metal reinforcing ring 1621 is thin in thickness and high in strength, the metal reinforcing ring is taken as an example in the embodiment of the present disclosure.

In the embodiment of the present disclosure, as shown in FIG. 30, the joint between the connecting portion 16 and the abutting portion 162 is a bevel transition structure 163. That is, an outer diameter of one end of the abutting portion 162 close to the connecting portion 16 gradually decreases until being same as the outer diameter of the connecting portion 16, so that an outer diameter of the joint between the connecting portion 16 and the abutting portion 162 does not change dramatically, thereby improving the structural strength of the joint between the connecting portion 16 and the abutting portion 162 and preventing breakage at the joint between the connecting portion 16 and the abutting portion 162 when the abutting portion 162 is excessively pressed by the inner peripheral wall 2111 of the inserting hole 211.

In order to further enhance the structural strength of the nozzle 100, in the embodiment of the present disclosure, the connecting portion 16, the abutting portion 162, and the outflow section 24 are an integrally formed structure, and the nozzle 100 is a plastic piece. The connecting portion 16, the abutting portion 162, and the outflow section 24 are the integrally formed structure, which enhances the overall structural strength of the nozzle 100. Specifically, the connecting portion 16, the abutting portion 162, and the outflow section 24 are integrally formed by injection molding. In addition, the nozzle 100 is the plastic piece. Since the plastic piece has good toughness and resilience, the abutting portion 162 also has good toughness and resilience. When the oral irrigator device 200 falls, the outer peripheral wall of the abutting portion 162 presses against the inner peripheral wall 2111 of the inserting hole 211. At this time, the abutting portion 162 elastically deforms to buffer an impact force of the oral irrigator device 200 when the oral irrigator device 200 falls. When the oral irrigator device 200 falls stably on the ground, the abutting portion 162 returns to an original shape.

Furthermore, an outer diameter of a portion of the outflow section 24 close to the abutting portion 162 gradually increases in a direction towards the abutting portion 162 (a direction toward the right shown in FIG. 30) to form the second stop flange 164. It is understood that when the user installs the nozzle 100 in the inserting hole 211, a palm of the hand holds the outflow section 24, and a thumb finger and an index finger pinch the portion of the outflow section 24 close to the abutting portion 162 to insert the connecting portion. 16 and the abutting portion 162 into the inserting hole 211. Since the outer diameter of the portion of the outflow section 24 close to the abutting portion 162 gradually increases in the direction towards the abutting portion 162, an outer diameter of a joint between the outflow portion 24 and the abutting portion 162 is maximum. When the connecting portion 16 and the abutting portion 162 are inserted into the inserting hole 211, the joint between the outflow section 24 and the abutting portion 16 provides a force point for the thumb finger and the index finger and limits the movement of the thumb finger and the index finger in the direction close to the abutting portion 162, thereby facilitating an installation of the nozzle 100. Moreover, the outer diameter of the portion of the outflow section 24 close to the abutting portion 162 gradually increases in the direction towards the abutting portion 162, which also increases a structural strength of one end of the outflow section 24 close to the abutting portion 162, thereby effectively avoiding the breakage at the outflow section 24.

Furthermore, anti-slip structures 241 are disposed on the outer peripheral wall of the outflow section 24. It is understood that when the nozzle 100 is installed in the inserting hole 211, or when the user needs to adjust a water outlet direction of the nozzle 100, it is necessary to hold the outflow section 24 to operate. The anti-slip structures 241 are disposed on the outer peripheral wall of the outflow section 24, and the anti-slip structures 241 play an anti-slip role when the user holds the outflow section 24, which prevent the hand of the user from sliding when holding the outflow section 24 and bring a good use experience to the user.

Specifically, the anti-slip structures 241 are ridges (not shown in the drawings) disposed on the outer peripheral wall of the outflow section 24. The anti-slip structures 241 increase a contact area between the palm of the user and the outflow section 24 when the user holds the outflow section 24, thereby increasing a frictional resistance between the palm of the user and the outflow section 24, facilitating the user to install or adjust the nozzle 100, and improving the user experience. Alternatively, the anti-slip structures 241 are flatten portions. The flatten portions refer to two flat surfaces disposed opposite to each other formed by whittling an outer wall of a cylindrical object. Since the cylindrical object is difficult to hold, by defining the two flatten portions, the cylindrical object is easily held through the two flatten portions. In the present disclosure, the flatten portions are defined on the outer peripheral wall of the outflow section 24. That is, two opposite flat surfaces are defined on the outer peripheral wall of the outflow section 24. When the user holds the outflow section 24, the thumb finger and the index finger respectively abut against the flatten portions, so that the thumb finger and the index finger apply forces to pitch the outflow section 24, and the outflow section 24 is difficult to move under the forces of the thumb finger and the index finger, thereby facilitating the user to install or adjust the nozzle 100 and improving the user experience.

In addition, in order to facilitate the user to hold the outflow section 24, a rubber sleeve (not shown in the drawings) may be sleeved on the outer peripheral wall of the outflow section 24. Since the rubber sleeve has good anti-slip properties and is soft, on the one hand, the rubber sleeve increases the frictional resistance between the palm of the user and the outflow section 24, and on the other hand, the rubber sleeve brings a comfort holding experience to the user.

The inventor found through extensive experimental research that dimensional parameters of the connecting portion 16 and the abutting portion 162 have an important impact on the anti-falling capacity of the nozzle 100.

Specifically, as shown in FIG. 33. a wall thickness of the connecting portion 16 is A, and 1.5 mm≤A≤2.5 mm. That is, a difference between the outer diameter and an inner diameter of the connecting portion 16 is 1.5-2.5 mm. When the wall thickness of the connecting portion 16 is 1.5-2.5 mm, the connecting portion 16 has better structural strength and avoids the abutting portion 162 from being greatly impacted when the oral irrigator device 200 falls, thus avoiding breakage of the nozzle 100 when the outer peripheral wall of the connecting portion 16 presses against the inner peripheral wall 2111 of the inserting hole and breaks. It should be noted that the wall thickness of the connecting portion 16 is 1.5 mm, 1.6 mm, 1.7 mm, 1.8 mm, 1.9 mm, 2.0 mm, 2.1 mm, 2.2 mm, 2.3 mm, 2.4 mm, 2.5 mm, etc., which is not specifically limited thereto, as long as the wall thickness of the connecting portion 16 enables the connecting portion 16 to have good structural strength.

Furthermore, a wall thickness of the abutting portion 162 is B, and 2 mm≤B≤3 mm. That is, a difference between the outer diameter and an inner diameter of the abutting portion 162 is 2 mm-3 mm. When the wall thickness of the abutting portion 162 is 2-3 mm, the structural strength of the abutting portion 162 is ensured, and the probability of breakage of the abutting portion 162 when the oral irrigator device 200 falls is reduced. It should be noted that the wall thickness of the abutting portion 162 is 2 mm, 2.1 mm, 2.2 mm, 2.3 mm, 2.4 mm, 2.5 mm, 2.6 mm, 2.7 mm, 2.8 mm, 2.9 mm, 3 mm, etc., which is not specifically limited thereto, as long as the abutting portion 162 has good structural strength,

Furthermore, the wall thickness of the connecting portion 16 is A. The wall thickness of the abutting portion 162 is B. 0.4 mm≤B−A≤0.7 mm. When a wall thickness difference between the connecting portion 16 and the abutting portion 162 is 0.4-0.7 mm, the wall thickness difference between the connecting portion 16 and the abutting portion 162 is not too large, thereby making a joint between the connecting portion 16 and the abutting portion 162 being less likely to break and improving connection stability between the connecting portion 16 and the abutting portion 162. It should be noted that the wall thickness difference between the connecting portion 16 and the abutting portion 162 is 0.4 mm, 0.45 mm, 0.5 mm, 0.55 mm, 0.6 mm, 0.65 mm, 0.7 mm, etc., which is not specifically limited thereto, as long as the wall thickness difference between the connecting portion 16 and the abutting portion 162 enables the connecting portion 16 and the abutting portion being stably connected.

In addition, a total length of the connecting portion 16 and the abutting portion 162 is C, and C≥10 mm. Since the connecting portion 16 and the abutting portion 162 need to be inserted into and fixed in the inserting hole 211, the total length of the connecting portion 16 and the abutting portion 162 is not less than 10 mm, which ensures a connection between the connecting portion 16, the abutting portion 162, and the inserting hole 211, and enables the nozzle 100 to work stably. It should be noted that the total length of the connecting portion 16 and the abutting portion 162 is 10 mm, 11 mm, 12 mm, 13 mm, 14 mm, 15 mm, 16 mm, 17 mm, 18 mm, 19 mm, 20 mm, etc., which is not specifically limited thereto, as long as the total length of the connecting portion 16 and the abutting portion 162 enables the connecting portion 16 and the abutting portion being stably connected to the inserting hole.

In order to further improve the anti-fall capability of the nozzle 100, the present disclosure improves the clamping groove 161 and the clamping assembly 3. Specifically, the clamping piece 31 is elastic. Since the clamping piece 31 is engaged with the clamping groove 161 to prevent the nozzle 100 form moving, when the oral irrigator device 200 falls, the abutting portion 162 presses against the inner peripheral wall 2111 of the inserting hole, and at the same time, the clamping piece 31 presses against a bottom portion of the clamping groove 161. Since the clamping piece 31 is elastic, the clamping piece 31 elastically deforms to buffer an impact force between the connecting portion 16 and the inner peripheral wall 2111 of the inserting hole, which prevents the connecting portion 16 from breaking and particularly prevents the connecting portion 16 from breaking at the clamping groove 161.

In order to avoid poor structural strength of the nozzle 100 due to presentation of the clamping groove 161, in the embodiment of the present disclosure, the clamping groove 161 is spaced apart from the abutting portion 162. That is, the clamping groove 161 is spaced apart from the joint between the clamping groove 16 and the abutting portion 162, thereby avoiding reducing the structural strength of the joint between the clamping groove 16 and the abutting portion 162. Therefore, connection stability between the clamping groove 16 and the abutting portion 162 is improved.

In some embodiments, as shown in FIGS. 29-30, the clamping groove 161 is an annular clamping groove, ribs 1611 are disposed on the bottom portion of the clamping groove 161, and the ribs 1611 are disposed at intervals along a circumferential direction of the connecting portion 16. An extension direction of each of the ribs 1611 is same as the extension direction of the connecting portion 16, and second grooves 311 matched with the ribs 1611 are defined on one side of the clamping piece 31 corresponding to the bottom portion of the clamping groove 161. Since the clamping groove 161 is the annular clamping groove, the clamping piece 31 only limits the clamping groove 161 from moving along the axial direction of the inserting hole 21 and does not limit the clamping groove 161 from rotating around the circumferential direction of the inserting hole 211. Therefore, the nozzle 100 is rotatable around the circumferential direction of the inserting hole 211. Since the ribs 1611 are disposed on the bottom portion of the clamping groove 161, and the second grooves 311 matched with the ribs 1611 are defined on the one side of the clamping piece 31 corresponding to the bottom portion of the clamping groove 161, when the nozzle 100 rotates around the axial direction of the inserting hole 211, the ribs 1611 continuously rub the second grooves 311 to make clicking sounds, thereby reminding the user that the nozzle 100 is rotated. In addition, when the connecting portion 16 and the abutting portion 162 of the nozzle 100 are inserted into and fixed in the inserting hole 211, and when the clamping piece 31 is engaged with the clamping groove 161, the ribs 1611 are respectively engaged with the second grooves 311 to make a clicking sound. When the clicking sound is heard, the user is reminded that the nozzle 100 is installed in place, thereby improving convenience of the user in installing the nozzle 100.

In some other alternative embodiments, the clamping groove 161 is the annular clamping groove. The second grooves are defined on the bottom portion of the clamping groove 161, and the second grooves 311 are disposed at intervals along the circumferential direction of the connecting portion 16. The ribs 1611 matched with the second grooves are disposed on the one side of the clamping piece 31 corresponding to the bottom portion of the clamping groove 161. Similarly, since the second grooves are defined on the bottom portion of the clamping groove 161, and the ribs 1611 matched with the second grooves are disposed on the one side of the clamping piece 31 corresponding to the bottom portion of the clamping groove 161, when the nozzle 100 rotates around the axis direction of the inserting hole 211, the ribs 1611 continuously rub the second grooves 311 to make the clicking sounds, thereby reminding the user that the nozzle 100 is rotated.

Furthermore, a depth of the clamping groove 161 is D, and D≤1 mm. That is, the depth of the clamping groove 161 is not greater than 1 mm, which on the one hand, ensures the structural strength of the connecting portion 16, and on the other hand, enables the clamping piece 31 being engaged with the clamping groove 161 to lock the nozzle 100. It should be noted that the depth of the clamping groove 161 is 0.5 mm, 0.6 mm, 0.7 mm, 0.8 mm, 0.9 mm, 1 mm, etc., which is not specifically limited thereto.

In addition, a wall thickness of a portion, where the clamping groove 161 is defined, of the connecting portion 16 is E, and E≥1 mm. That is, a distance between the bottom portion of the clamping groove 161 and the water outlet channel 13 is not less than 1 mm. The wall thickness of the portion, where the clamping groove 161 is defined, of the connecting portion 16 is not less than 1 mm, which ensures that the connecting portion 16 has good structural strength even the clamping groove 161 is defined thereon, so that the nozzle 100 works stably. It should be noted that the wall thickness of the portion, where the clamping groove 161 is defined, of the connecting portion 16 is 1 mm, 1.2 mm, 1.4 mm, 1.6 mm, 1.8 mm, 2.0 mm, etc., which is not specifically limited thereto.

As shown in FIGS. 26, 28, and 29, in order to well connect the nozzle 100 to the irrigator body 210, the oral irrigator device 200 further defines a water outlet 212, and the clamping assembly 3 further comprises a moving piece 33, a fixing piece 34 and a button. 35.

The fixing piece 34 is sleeved on the water outlet 212, and the fixing piece 34 defines a second notch 341. The moving piece 33 is sleeved on the fixing piece 34. The clamping piece 31 is connected to an inner side of the moving piece 33 and corresponds to the second notch 341. A first end of each of the elastic pieces 32 abuts against the moving piece 33. A second end of each of the elastic pieces 32 abuts against the housing 210a. The button 35 abuts against the moving piece 33. When the nozzle 100 needs to be fixed in the inserting hole 211, the button 35 is pressed to drive the moving piece 33 to compress the elastic pieces 32, so that the clamping piece 31 extends out of the second notch 341. At this time, an interior of the fixing piece 34 is unobstructed, allowing the connecting portion 16 and the abutting portion 162 being inserting into the fixing piece 34. Then the button 35 is released, and the elastic pieces 32 return to move the moving piece 33, thereby driving the clamping piece to extend into the second notch 341 and being engaged with the clamping groove 161 disposed on the connecting portion 16. Therefore, the nozzle 100 is fixed in the inserting hole 211. When the nozzle 100 needs to be detached, the button 35 is pressed to drive the moving piece 33 to compress the elastic pieces 32, so that the clamping piece 31 is separated from the clamping groove 161 and then extends out of the second notch 341. At this time, the nozzle 100 is capable of being pulling out of the inserting hole 211.

In addition, in order to improve use stability of the oral irrigator device 200, a sealing ring 4 is disposed between the outer peripheral wall of the connecting portion 16 and the inner wall of the water outlet 212. Since the sealing ring 4 is generally a flexible piece such as rubber, the sealing ring 4 seals a gap between the outer peripheral wall of the connecting portion 16 and an inner peripheral wall of the water outlet 212 to prevent water from leakage at the gap between the outer peripheral wall of the connecting portion 16 and the inner peripheral wall of the water outlet 212. Moreover, when the oral irrigator device 200 falls, the sealing ring 4 also buffers an impact force between the outer peripheral wall of the connecting portion 16 and the inner peripheral wall of the water outlet 212 to prevent the connection portion 16 from breaking.

The above embodiments of the present disclosure provide a detailed illustration to the differential power amplifier. In the present disclosure, specific embodiments are applied to illustrate the principles and implementations of the present disclosure. The above description of the embodiments is only used to better understand methods and core ideas of the present disclosure. Meanwhile, according to the ideas of the present disclosure, changes are made in the specific implementations and the application scope by those skilled in the art. Therefore, the contents of the specification should not be regarded as a limitation of the present disclosure.

What is claimed is:

1. A nozzle of an oral irrigator device, comprising:
an outlet,
a main body portion, and
an extension portion connected to one end of the main body portion;
wherein the extension portion comprises a free end disposed away from the main body portion; the outlet is defined on an end surface of the free end of the extension portion; at least one section of an outer contour of the end surface of the free end of the extension portion is straight.

2. The nozzle according to claim 1, wherein the nozzle defines a first direction, a second direction, and a third direction; the first direction, the second direction, and the third direction are perpendicular to each other; the main body portion is extended along the first direction; the extension portion obliquely extends along the second direction away from the main body portion; the extension portion comprises a first side wall and a second side wall disposed opposite to the first side wall; the first side wall and the second side wall are disposed along the third direction; the end surface of the free end of the extension portion intersects the first side wall to define a first intersection edge; the end surface of the free end of the extension portion intersects the second side wall to define a second intersection edge; at least one of the first intersection edge and the second intersection edge is a straight edge.

3. The nozzle according to claim 2, wherein at least one of the first side wall and the second side wall is a flat surface, and the at least one of the first side wall and the second side wall that is the flat surface extends along the second direction and intersects with the end surface of the free end of the extension portion to form the at least one straight edge.

4. The nozzle according to claim 3, wherein the at least one of the first side wall and the second side wall that is the flat surface extends from the extension portion to the main body portion, and the at least one of the first side wall and the second side wall that is the flat surface extends to a midpoint of the main body portion along a length direction of the main body portion.

5. The nozzle according to claim 2, wherein along the first direction, the at least one straight edge is obliquely disposed toward the main body portion; an included angle between the at least one straight edge and the first direction ranges from 0-60 degrees.

6. The nozzle according to claim 2, wherein the end surface of the free end of the extension portion intersects with the first side wall and the second side wall to form two straight edges; the two straight edges are parallel to each other;
wherein in an outer contour of the end surface of the free end of the extension portion; a first connecting section is connected to a first end of each of the two straight edges; a second connecting section is connected to a second end of each of the two straight edges; the first connecting section and the second connecting section are arc-shaped; the first connecting section is arched up toward a direction away from the second connecting section; the second connecting section is arched up toward a direction away from the first connecting section.

7. The nozzle according to claim 2, wherein the free end of the extension portion defines at least one notch; the at least one notch is defined on the end surface of the free end of the extension portion; the at least one notch penetrates an outer peripheral surface of the extension portion; the at least one notch is communicated with the outlet.

8. The nozzle according to claim 7, wherein the at least one notch intersects with at least part of the at least one straight edge.

9. The nozzle according to claim 7, wherein a part of the end surface of the free end of the extension portion is recessed to define a groove; the outlet is defined on a bottom surface of the groove; the at least one notch penetrates a peripheral wall of the groove; the outlet is spaced apart from the peripheral wall of the groove.

10. The nozzle according to claim 9, wherein at least part of the peripheral walls of the groove forming the at least one notch is smooth or round.

11. The nozzle according to claim 10, wherein in a direction from the peripheral wall of the groove to the outer peripheral surface of the extension portion, the at least part of the peripheral walls of the groove forming the at least one notch is a convex curved surface.

12. The nozzle according to claim 2, wherein the outlet is a long-narrow-shaped hole; an extension direction of a cross-section of the outlet taken along the second direction is same as an extension direction of the at least one straight edge.

13. The nozzle according to claim 2, wherein a water outlet channel is defined in the nozzle; the water outlet channel comprises a liquid outlet section; the liquid outlet section defines a liquid inlet and the outlet; areas of cross sections of the water outlet channel perpendicular to a water outlet direction of the liquid outlet section gradually increase.

14. The nozzle according to claim 13, wherein in the cross sections of the water outlet channel perpendicular to the water outlet direction of the liquid outlet section, widths of the cross sections, corresponding to the liquid outlet section, of the water outlet channel are unchanged, and lengths of the cross sections, corresponding to the liquid outlet section, of the water outlet channel gradually increase.

15. The nozzle according to claim 14, wherein a ratio of an area of the liquid inlet to an area of the outlet is 0.45-0.8.

16. The nozzle according to claim 15, wherein the liquid inlet is square, and the outlet is rectangular; long edges of the outlet are parallel to the at least one straight edge.

17. The nozzle according to claim 12, wherein the outlet is spaced apart from the at least one straight edge.

18. An oral irrigator device, comprising:
an irrigator body defining an inserting hole, and
a nozzle detachably connected to the irrigator body,
wherein the nozzle comprises an outlet, a main body portion, and an extension portion; the oral irrigator device defines a first direction, a second direction, and a third direction; the first direction, the second direction, and the third direction are perpendicular to each other;
wherein the main body portion extends along the first direction away from the irrigator body; the extension portion is connected to one end of the main body portion; the extension portion comprises a free end; the outlet is defined on an end surface of the free end of the extension portion; at least one section of an outer contour of the end surface of the free end of the extension portion is straight.

19. The oral irrigator device according to claim 18, wherein the main body portion comprises a connecting portion, an abutting portion, and an outflow section; the connecting portion, the abutting portion, and the outflow section are connected in sequence; the connecting portion and the abutting portion are inserted into the irrigator body from the inserting hole; the outflow section is exposed out of the irrigator body; the abutting portion is matched with the inserting hole; a gap is defined between an outer peripheral wall of the abutting portion and an inner peripheral wall of the inserting hole; a clamping groove is defined in the connecting portion; a portion, close to the abutting portion, of the outflow section extends outwards in a radial direction of the inserting hole to form a stop flange; the stop flange abuts against an outer end surface of the inserting hole;
the oral irrigator device further comprises a clamping assembly; the clamping assembly comprises a clamping piece and elastic pieces; the elastic pieces are configured to connect the clamping assembly to the irrigator body; the clamping piece is engaged with the clamping groove to stop movement of the nozzle along an axial direction of the inserting hole.

20. The oral irrigator device according to claim 18, wherein the clamping groove is an annular groove; a surface of the clamping groove is uneven; the clamping piece contacts the surface of the clamping groove, so as to increase a rotation resistance between the nozzle and the irrigator body.
